(19) United States
(12) Patent Application Publication
(10) Pub. No.: US 2016/0349670 A1
(43) Pub. Date: Dec. 1, 2016

(54) IMAGE FORMING APPARATUS

(71) Applicant: CANON KABUSHIKI KAISHA, Tokyo (JP)

(72) Inventors: Kenta Kubo, Kamakura-shi (JP); Shunichi Takada, Soka-shi (JP); Koichi Hashimoto, Yokohama-shi (JP)

(21) Appl. No.: 15/159,871

(22) Filed: May 20, 2016

(30) Foreign Application Priority Data
May 29, 2015 (JP) 2015-110639

(51) Int. Cl. G03G 15/08

(52) U.S. Cl. CPC G03G 15/095; G03G 15/0921

(57) ABSTRACT

A developer supply member, a toner collecting member, and a transfer member are arranged in order from an upper stream in a rotation direction of a developer bearing member, the developer bearing member bears an electrostatic image and includes a plurality of concave portions, a proportion of the concave portions per unit area in at least a toner bearing region of the developer bearing member is 55% or higher, a difference of potential is formed between the developer bearing member and the toner collecting member, and the toner t on the surface of the developer bearing member is collected through the difference of potential.

### BACKGROUND OF THE INVENTION

Field of the Invention

The present invention relates to an image forming apparatus using an electrophotographic system such as a copying machine, a printer, or a facsimile.

Description of the Related Art

In recent years, there has been a demand for an image forming apparatus capable of outputting a high-quality image with a small toner amount in order to reduce energy consumption. If it is possible to reduce the toner amount, energy necessary for processes such as development, transfer, and fixing is reduced. In order to reduce the toner amount, it is required to stably output a “thin-layer” toner image at a “high density”.

FIG. 33A illustrates a state of a high-density thin-layer toner borne on the surface of a developer bearing member pursued by an image forming apparatus of the present invention, an upper drawing is a plane view of a toner on a developer bearing member, and a lower drawing is a cross-sectional view taken along line by a broken line in the upper drawing. Since the developer bearing member is covered with the toner at a high density, an area size of a white background portions in which the surface of the developer bearing member in the plane view is narrow, and a variation in the area sizes in the white background portions is small as well.

FIG. 33B illustrates a state of a toner borne on a surface of an developer bearing member using an image forming apparatus according to a related art, an upper drawing is a plane view of a toner on the developer bearing member, and a lower drawing is a cross-sectional view taken along a broken line in the upper drawing. A toner of a first layer is not arranged on the developer bearing member at a high density, and a multi-layered portion is tangible. For this reason, in FIG. 33B, even at the same toner amount as in FIG. 33A, the area size of the white background portion is large, the density is low, and it is non-uniform, and thus the variation in the area sizes of the white background portions is large, and a very large white background portion is exposed depending on a position.

When the toner image is transferred and fixed to a medium, the toner image is melted and spread by the fixing, and thus the white background portions are filled with the melted toner, but the white background portions are not filled, and an image noise occurs due to a decrease in an image density or an increase in a variation in density within an image plane.

In order to prevent the state of FIG. 33B and achieve the state of FIG. 33A, inventions of Japanese Patent Laid-Open No. 2001-228705 and Japanese Patent Laid-Open No. 2001-175079 have been proposed. In Japanese Patent Laid-Open No. 2001-228705, a developing apparatus that includes a first regulating portion of causing a thin plate metallic spring to abut a developing roller using a non-magnetic one-component toner and a second regulating portion that causes a rubbery elastic body to abut at a downstream position further than the abutting position of the thin plate metallic spring in a rotation direction of the developing roller and forms a uniform thin layer of toner has been proposed.

In Japanese Patent Laid-Open No. 2001-175079, a developing apparatus that causes a rotatable regulating member to abut a developing roller and forms a uniform thin layer of toner through a hybrid developing system that separates only a toner of a developer by an electric field using a two-component developer configured with a toner and a magnetic carrier and causes the toner to be borne on the developing roller has been proposed.

However, in the techniques disclosed in Japanese Patent Laid-Open No. 2001-228705 and Japanese Patent Laid-Open No. 2001-175079, it was turned out that it is hard to stably obtain a “thin-layer” toner image on the image bearing member at a “high density.” The cause was turned out to be mainly “defective coating” and “disturbance at the time of development” on the developing roller. This is described below in detail.

### (Defective Coating)

In the techniques disclosed in Japanese Patent Laid-Open No. 2001-228705 and Japanese Patent Laid-Open No. 2001-175079, it is necessary to cause the regulating member to abut the developing roller with a high degree of accuracy mechanically, and it is difficult to guarantee the “thin layer” over a long period of time due to a mechanical error of each member, abrasion of the regulating member, or the like.

FIG. 33C is a cross-sectional view of a non-magnetic one-component developing apparatus, and FIG. 33D is a cross-sectional view of a hybrid developing apparatus. It is well known that it is difficult to supply a stable toner amount to a developing roller through a supply member of FIG. 33C or a supply member of FIG. 33D in which a permanent magnet is arranged. For example, in the non-magnetic one-component developing apparatus, as the charging property of the toner decreases, the conveyance property decreases, and the toner amount is likely to decrease. Further, in the hybrid developing apparatus, as the charge amount of the toner increases, the toner amount is likely to decrease. As a result, the density of the toner abruptly decreases, and it is difficult to achieve the above-described “high density.”

### (Disturbance at Time of Development)

Even when A toner layer with which the developing roller is coated migrates to the image bearing member and developed, two or more layers of toner are formed, or the density of the toner decreases. The “developing” refers to a phenomenon that an electric field is applied to a toner having a charge amount due to a difference of potential between the developing roller and the image bearing member, and the toner migrates from the developing roller to a latent image portion of the image bearing member. At this time, although the electric field is applied, the migration does not necessarily start uniformly due to a difference in particle diameters, the charge amount, or adhesion force of the toners or the like.

For example, in the non-magnetic one-component developing apparatus, the toner does not necessarily migrate in order at a point in time at which the developing roller comes into contact with the image bearing member. In practice, a certain toner undergoes so-called jumping development in which it flies in a non-contact state before and after the contact, or a certain toner migrates while passing a contact nip, and thus the migration is not uniform.

For this reason, the toner layer is disturbed while the toner migrates from the developing roller to the image bearing member, and thus two or more layers of toner are likely to be formed, or the density of the toner is likely to decrease. Particularly, an edge portion of the latent image is likely to be influenced by the jumping development and have two or more layers of toner. If the two or more layers of toner are locally formed as described above, an absolute toner amount is not enough, and the density of a portion other than the edge portion abruptly decreases. On the other hand, if the density of the toner is increased, the overall toner has two or more layers. In other words, an increase in density of a toner is in a trade-off relation with a decrease in layer thickness of a toner.

FIG. 34 illustrates a height profile of the toner layer on the image bearing member when a line latent image of 84 μm having 3 lines and a 1 space is developed under a condition that a toner amount corresponding to a single layer is developed for a solid latent image using a non-magnetic one-component developing apparatus. In FIG. 34, a dotted line arrow indicates a height rt. rt is an average particle diameter rt of a toner used at this time. The heights of the toner layer in the respective line portions are irregular, and particularly, a line rear end portion X is formed of two or three layers. In addition, a toner density is also low, and exposed portions Y in which the surface of the image bearing member is exposed are scattered here and there. Further, there is a difference in the height of the toner layer and the toner density between lines. The irregularity in the height of the toner layer (two or more toner layers) or the decrease in the toner density (low toner density) causes an image noise or decrease an image density.

### SUMMARY OF THE INVENTION

An image forming apparatus according to one aspect of the present invention includes a developing container that accommodates a developer, a developer bearing member that is arranged in an opening of the developing container and bears the developer, a developer supply member that is arranged in the developing container and supplies the developer to the developer bearing member, a toner collecting member that is arranged in the developing container and collects a toner with which the developer bearing member is coated, and a transfer member that transfers a toner image remaining on the developer bearing member to a transfer material after the collecting, the developer supply member, wherein the toner collecting member, and the transfer member are arranged in order from an upstream side in a rotation direction of the developer bearing member, the developer bearing member bears an electrostatic image and includes a plurality of concave portions, and a proportion of the concave portions per unit area in at least a toner bearing region of the developer bearing member is 55% or higher, a difference of potential is formed between the developer bearing member and the toner collecting member, and the toner on a surface of the developer bearing member is collected through the difference of potential.

An image forming apparatus according to another aspect of the present invention, includes a developing container that accommodates a developer, a developer bearing member that is arranged in an opening of the developing container and bears the developer, a latent image forming apparatus that forms an electrostatic latent image on the developer bearing member, a developer supply member that is arranged in the developing container and supplies the developer to the developer bearing member, a toner collecting member that is arranged in the developing container and collects a toner with which the developer bearing member is coated, and a transfer member that transfers a toner image remaining on the developer bearing member to a transfer material after the collecting, wherein the developer supply member, the toner collecting member, and the transfer member are arranged in order from an upstream side in a rotation direction of the developer bearing member, and the developer bearing member bears an electrostatic image and includes a plurality of concave portions, and each of the concave portions is configured such that a virtual ball having an average particle diameter of the toner is contactable to an inner surface of the concave portion except an edge of the concave portion formed at an outmost surface side of the developer bearing member of the concave portion, and the virtual ball protrudes outwards further than an outmost surface position of the developer bearing member when the virtual ball is positioned at a lowest position in the concave portion, a proportion of the concave portions per unit area in at least a toner bearing region of the developer bearing member is 55% or higher, and a difference of potential is formed between the developer bearing member and the toner collecting member, and the toner borne on a non-image region of the developer bearing member is collected through the difference of potential.

According to the present invention, it is possible to form a toner image of a high density thin layer stably, and it is possible to output a high-quality image with a small toner amount.

Further features of the present invention will become apparent from the following description of exemplary embodiments with reference to the attached drawings.

### BRIEF DESCRIPTION OF THE DRAWINGS

FIG. 1 is a schematic diagram illustrating an image forming apparatus 100 using an electrophotographic system according to a first embodiment;

FIG. 2A is a cross-sectional view of a developing apparatus, and FIG. 2B is a schematic diagram illustrating a surface of a developer supply member;

FIG. 3A is a perspective view illustrating a developer bearing member, and FIG. 3B is a partially enlarged perspective view of FIG. 3A;

FIG. 4A is a cross-sectional view of a developer bearing member, and FIG. 4B is a cross-sectional view of a concave-convex structure portion;

FIG. 5A is a cross-sectional view of a developing apparatus illustrating a movement state of a toner, and FIG. 5B is a schematic diagram illustrating a supply portion;

FIG. 6A is a schematic diagram illustrating a regulating portion, and FIG. 6B is a schematic diagram illustrating a toner collecting portion;

FIG. 7A is a schematic diagram illustrating toner behavior in a non-contact region, and FIG. 7B is a schematic diagram illustrating when there is no concave portion;

FIG. 8A is a schematic diagram illustrating toner behavior in a contact region, and FIG. 8B is a schematic diagram illustrating toner behavior in a non-contact region;

FIG. 9A is a schematic diagram illustrating toner behavior in a contact region, and FIG. 9B illustrates a profile of a height Z (μm) of a toner layer on a developer bearing member before transfer when a line latent image of 84 μm having 3 lines and a 1 space is developed;

FIG. 10A is a schematic diagram illustrating a forming method using a thermal nanoimprint technique, FIG. 10B is a schematic diagram illustrating a forming method using a diamond edging technique, and FIG. 10C illustrates a shape (γ) of a cross section of a rotating shaft j in a vertical direction s when a shape is measured using a non-contact surface/layer cross section shape measurement system VertScan2.0 (available from Ryoka systems, Inc.);

FIG. 11A is a schematic diagram for describing sampling, FIG. 11B illustrates a shape obtained by scanning a rotating shaft j with a probe in a vertical direction s and measuring a leading end position of each probe, similarly to a measurement of the shape γ, and FIG. 11C is a diagram illustrating a concave-convex shape obtained by a probe;

FIGS. 12A and 12B are schematic diagrams of leading end shapes of two types of cantilevers (probes);

FIGS. 13A to 13E are schematic diagrams illustrating a concave portion St (FIG. 13A) in which a difference (β−α) is rt or less and a concave portion St (FIG. 13B) that does not satisfy the condition;

FIG. 14A illustrates an example of a concave-convex structure portion according to the present invention, FIG. 14B is a perspective view illustrating a developer bearing member, and FIG. 14C is a schematic diagram illustrating an upper diagram of a developer bearing member and a concave-convex structure portion;

FIG. 15A is a schematic diagram illustrating a developer bearing member, FIG. 15B illustrates a result of extracting concave portions (painted portions) when a surface layer surface is scanned (broken lines a, b, and c) with a probe in a vertical direction s, and FIG. 15C illustrates a relation between a variation rate of a coating amount and a color difference ΔE of a developer bearing member;

FIGS. 16A to 16C are schematic diagrams illustrating examples of a structure portion according to the present invention;

FIGS. 17A to 17C are schematic diagrams illustrating examples of a structure portion according to the present invention;

FIG. 18A is a perspective view illustrating a developer bearing member, FIG. 18B is an enlarged plane view of a developer bearing member, and FIG. 18C is a cross-sectional view of FIG. 18B;

FIG. 19 is a schematic diagram illustrating a surface of a developer supply member;

FIGS. 20A and 20B are schematic configuration diagrams illustrating an embodiment of an image forming apparatus of the present invention;

FIG. 21A is a schematic configuration diagram illustrating an embodiment of an image forming apparatus of the present invention, and FIG. 21B is a schematic diagram illustrating a latent image bearing member configuring a developer bearing member;

FIG. 22A is a schematic diagram illustrating a cross section of a latent image bearing member in a direction of a rotating shaft j, and FIG. 22B is a schematic diagram illustrating a cross section of a developer bearing member in a circumferential direction;

FIG. 23 is a schematic configuration diagram illustrating an image forming apparatus according to a second embodiment of the present invention;

FIG. 24A is a schematic diagram illustrating a cross section of a developer bearing member, and FIG. 24B is a schematic diagram illustrating a cross section of a toner collecting member;

FIG. 25A is a schematic configuration diagram illustrating an image forming apparatus according to a third embodiment of the present invention, and FIG. 25B is a schematic diagram illustrating behavior of a developer in a supply portion;

FIG. 26A is a schematic diagram illustrating a charging sequence in the case of a positive polarity toner, FIG. 26B is a schematic diagram illustrating a charging sequence in the case of a negative polarity toner, FIG. 26C is a schematic diagram illustrating an inappropriate charging sequence, and FIG. 26D illustrates a result of measuring a coverage rate of a toner with which a concave-convex structure portion is coated when a coating rate is varied by adjusting a toner weight ratio (hereinafter, a “TD ratio”) of a two-component developer;

FIG. 27 is a schematic configuration diagram illustrating an image forming apparatus according to a modified example of the third embodiment of the present invention;

FIG. 28 is a schematic configuration diagram illustrating an image forming apparatus according to a fourth embodiment of the present invention;

FIG. 29A is a schematic diagram illustrating a cross section of a developer bearing member, and FIG. 29B is a schematic diagram for describing behavior of a two-component developer on a concave-convex structure portion in a conveyance process;

FIG. 30 is a schematic configuration diagram illustrating an image forming apparatus according to a modified example of the fourth embodiment of the present invention;

FIG. 31 is a schematic configuration diagram illustrating an image forming apparatus according to a fifth embodiment of the present invention;

FIG. 32 is a schematic configuration diagram illustrating an image forming apparatus according to a modified example of the fifth embodiment of the present invention;

FIG. 33A illustrates a state of a high-density thin-layer toner borne on the surface of a developer bearing member pursued by an image forming apparatus of the present invention, wherein an upper drawing is a plane view of a toner on a developer bearing member, and a lower drawing is a cross-sectional view taken along line by a broken line in the upper drawing, FIG. 33B illustrates a state of a toner borne on a surface of an image bearing member using an image forming apparatus according to a related art, wherein an upper drawing is a plane view of a toner on an image bearing member, and a lower drawing is a cross-sectional view taken along a broken line in the upper drawing, FIG. 33C is a cross-sectional view of a non-magnetic one-component developing apparatus, and FIG. 33D is a cross-sectional view of a hybrid developing apparatus; and

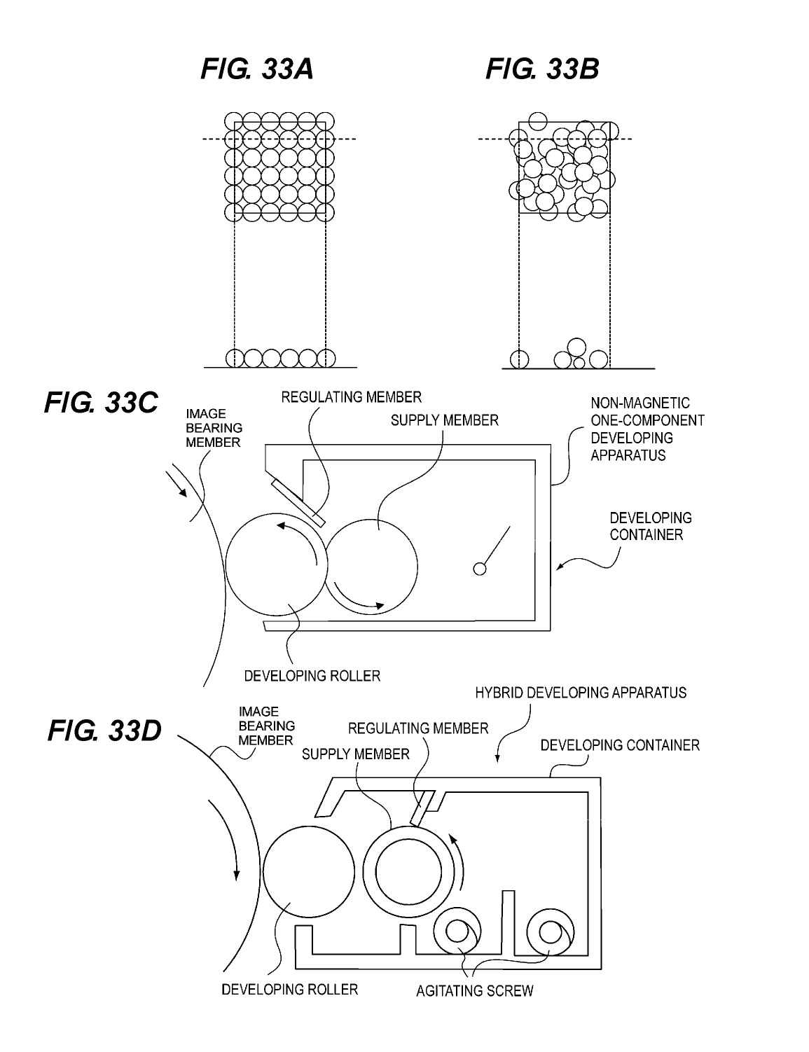

FIG. 34 illustrates a height profile of a toner layer on an image bearing member when a line latent image of 84 μm having 3 lines and a 1 space is developed under a condition that a toner amount corresponding to a single layer is developed for a solid latent image using a non-magnetic one-component developing apparatus, wherein a dotted line arrow indicates a height rt.

### DESCRIPTION OF THE EMBODIMENTS

Hereinafter, modes for carrying out the invention will be described with reference to the appended drawings based on exemplary embodiments. For example, dimensions, materials, shapes, and relative positions of components described in the following embodiments are appropriately changed according to a configuration of a device to which the invention is applied or various kinds of conditions and not intended to limit the scope to the invention thereto except as otherwise set forth herein. In a subsequent embodiment, the same components as in a preceding embodiment will be denoted by the same reference numerals, and a description of a preceding embodiment is employed.

### First Embodiment

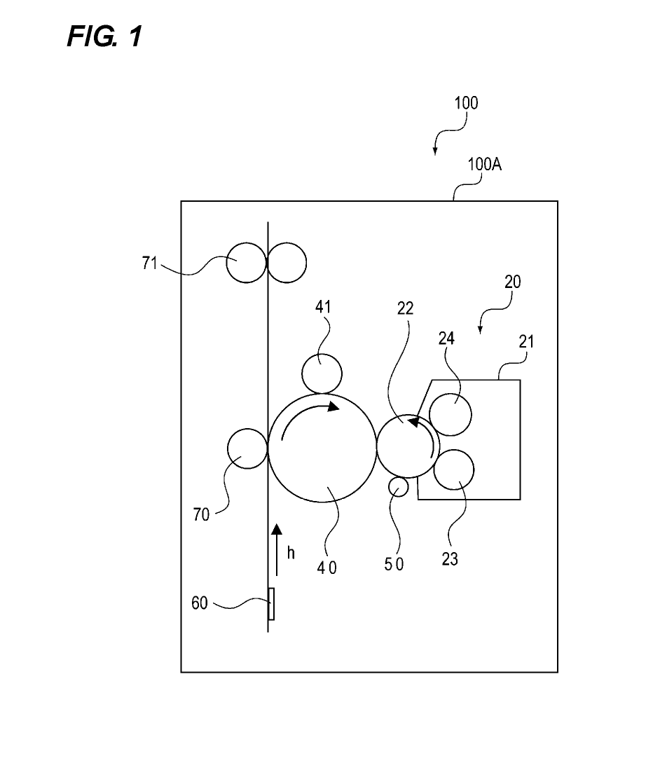

FIG. 1 is a schematic diagram illustrating an image forming apparatus 100 using an electrophotographic system according to a first embodiment. The image forming apparatus 100 includes an apparatus body 100A. The image forming apparatus 100 forms a high-density thin-layer toner image on a developer bearing member 22 through a developing apparatus 20 according to a latent image pattern formed by a latent image forming member 50. A toner image is transferred to the transfer member 40 and fixed onto a transfer material 60 through the transfer fixing member 70, the fixing member 71, and the like. A transfer toner residue on the transfer member 40 is cleaned by the cleaning member 41.

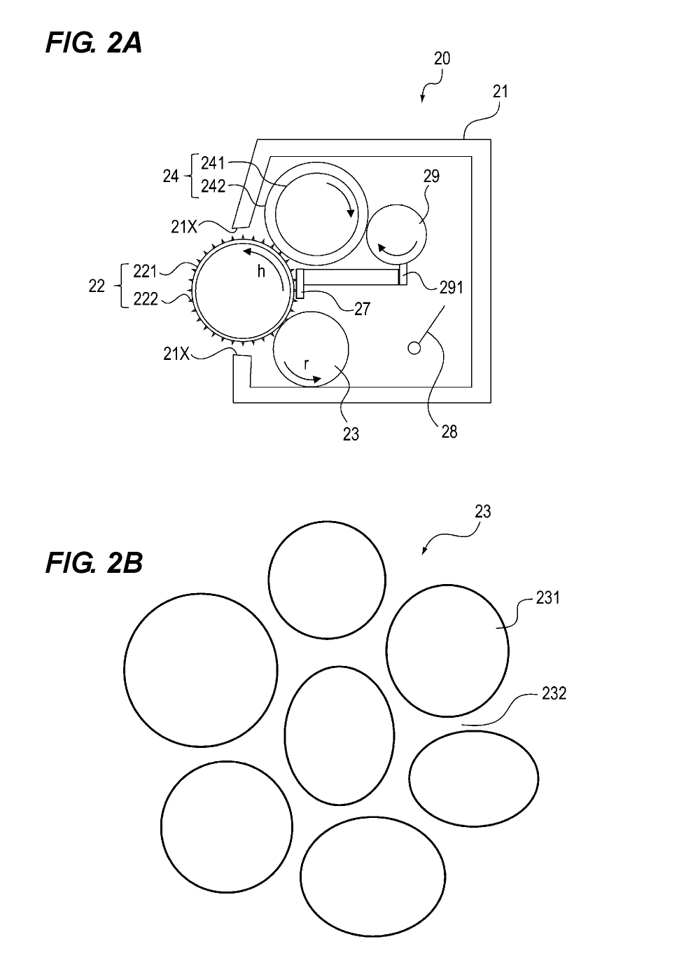

FIG. 2A is a cross-sectional view of the developing apparatus 20. The developing apparatus 20 includes a developing container 21, an agitating member 28, the developer bearing member 22, a developer supply member 23, a regulating member 27, a toner collecting member 24, and a cleaning member 29.

The developing container 21 accommodates a developer. The agitating member 28 agitates the developer, and supplies the developer to the developer supply member 23 which will be described later. The developer supply member 23 is arranged in the developing container 21, and supplies the developer to the developer bearing member 22. The developer bearing member 22 and the developer supply member 23 are arranged at a position at which they come into contact with each other. The developer bearing member 22 is arranged in an opening 21X of the developing container 21, and conveys the developer up to a transfer portion facing the transfer member 40 while bearing the developer.

A regulating member 27 regulates the thickness of the toner layer on the developer bearing member 22. A toner collecting member 24 is arranged in the developing container 21, and collects a toner t of a non-image portion with the developer bearing member 22 is coated at a position which is an upstream side further than the developer supply member 23 and is a downstream side further than the transfer member 40 in a rotation direction h of the developer bearing member 22. The developer bearing member 22 and the toner collecting member 24 are arranged at a position at which they come into contact with each other. The cleaning member 29 cleans the toner collecting member 24. The transfer member 40 transfers the toner image remaining on the developer bearing member 22 to the transfer material 60 after the collecting (see FIG. 1).

In the present embodiment, the developer is a one-component developer, and a non-magnetic negative charged toner in which a number average particle diameter (D50) rₜ and an average degree of circularity of toners manufactured by a polymerization method are 6.8 μm and 0.97 was used. The average degree of circularity is preferably 0.95 or more so that two or more layers of toner are not formed on the developer bearing member 22. A method of measuring the average particle diameter rt and the average degree of circularity of the toners will be described later.

FIG. 2B is a schematic diagram illustrating the surface of the developer supply member 23. For example, the developer supply member 23 is formed of a porous foam material whose surface has elasticity. On the surface of the developer supply member 23, there are a plurality of cells 231 having a diameter of 100 μm with a cell wall 232 interposed therebetween. In the present embodiment, an elastic sponge roller that forms polyurethane foams having relatively low hardness with a foam skeletal structure on a cored bar was used.

A foam material is not limited to a urethane foam, and a rubber material that is commonly used such as nitrile rubber, silicone rubber, acrylic rubber, hydrin rubber, ethylene propylene rubber can be used. The toner supplied by the agitating member 28 is filled in the foam material on the surface of the developer supply member 23 and is conveyed up to a supply portion that comes into contact with the developer bearing member 22.

In the supply portion, the filled toner is charges by contact with the developer bearing member 22 and migrated onto the developer bearing member 22. The developer supply member 23 also has a function of peeling off the transfer toner residue remaining on the developer bearing member 22 after the transfer. Since the developer supply member 23 undertakes this role, the developer supply member 23 is also called a remove&supply (RS) member. The developer supply member 23 rotates in an opposite direction r to the rotation direction h of the developer bearing member 22 in the supply portion.

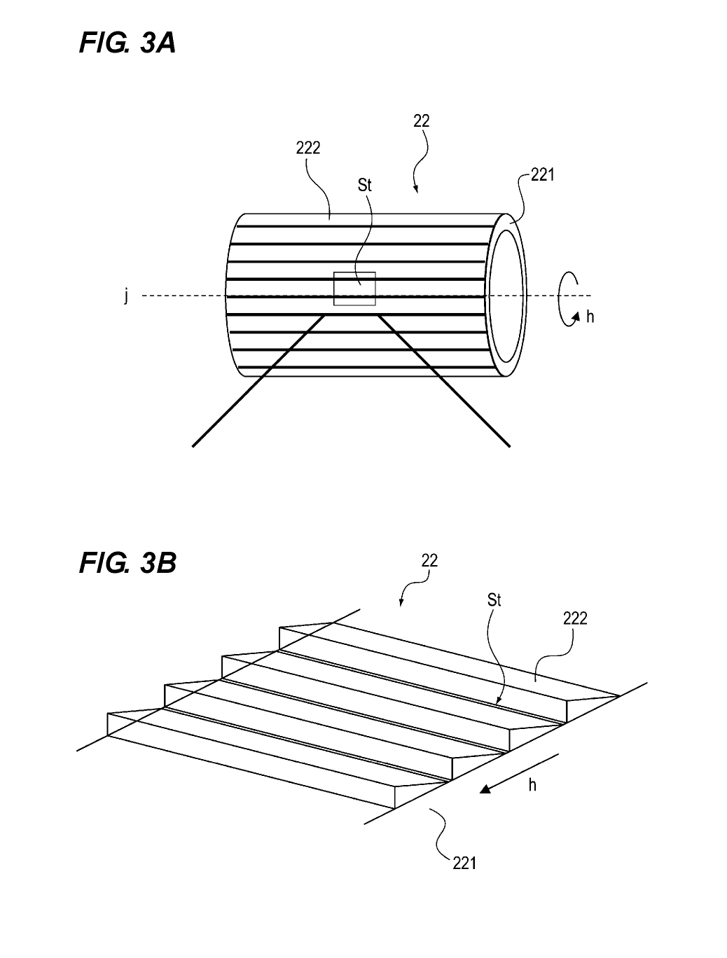

FIG. 3A is a perspective view illustrating the developer bearing member 22. FIG. 3B is a partially enlarged perspective view of FIG. 3A. The developer bearing member 22 is mainly configured with a latent image bearing member 221 that bears a latent image and a concave-convex structure portion 222 having a plurality of concave portions St having a surface which the toner is contactable. The developer bearing member 22 rotates on a rotating shaft j in a direction indicated by an arrow h, and includes a plurality of grooves that is formed on the surface thereof substantially in parallel to the rotating shaft j (FIG. 3A). In the present embodiment, a negative charge OPC photosensitive drum is used as the latent image bearing member 221.

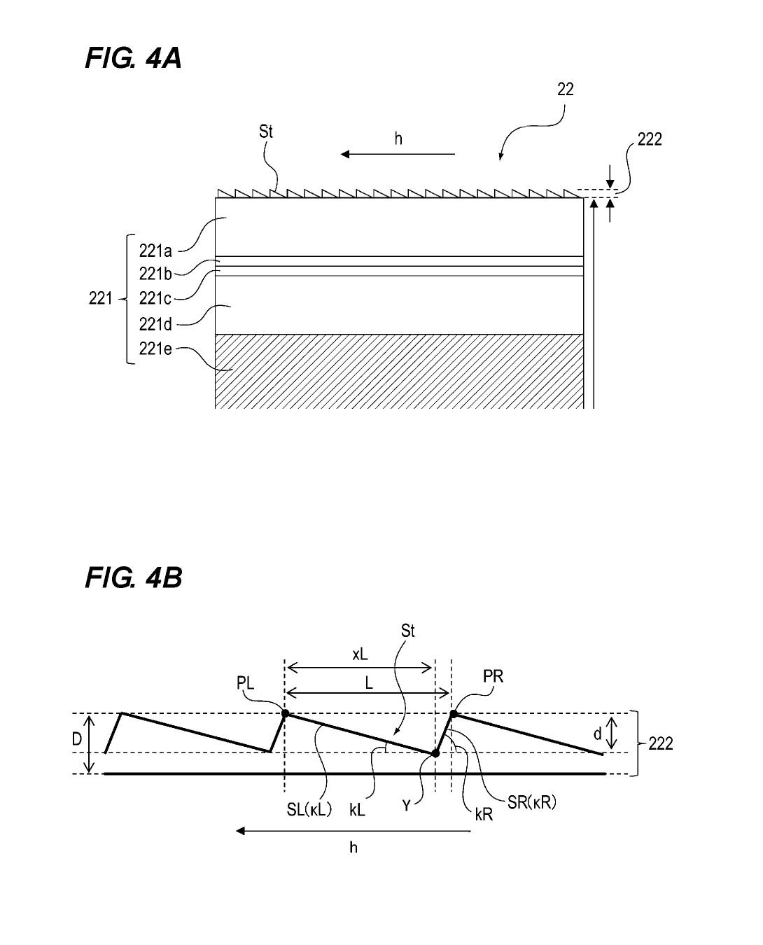

FIG. 4A is a schematic diagram illustrating a cross section of the developer bearing member 22. The developer bearing member 22 includes the latent image bearing member 221 that bears an electrostatic image and the concave-convex structure portion 222 including a plurality of concave portions St having a surface to which the toner t is contactable.

The latent image bearing member 221 includes the following five functional layers. A first layer serving as a lowest layer is a drum supporting member 221e made of aluminum. A second layer is an undercoat layer 221d and formed to smooth a defect of the drum supporting member 221e or the like and prevent the occurrence of moiré by reflection of laser light exposure. A third layer is a positive charge injection layer 221c (UCL) and formed to prevent the negation of negative charges injected from the drum supporting member 221e.

A fourth layer is a charge generation layer 221b (CGL) and formed to generate a pair of positive and negative charges by undergoing laser light exposure. A fifth layer is a charge transport layer 221a (CTL). Since the fifth layer is made of a P type semiconductor, negative charges charged to the surface of the photosensitive drum hardly moves in this layer, and thus the charge transport layer 221a is formed to transport only positive charges generated in the charge generation layer 221b to the surface of the photosensitive drum.

The concave-convex structure portion 222 made of a dielectric material is formed on the charge transport layer 221a. In the present embodiment, an overcoat layer (OCL) made of an acrylic resin material is formed on the charge transport layer 221a, and concave portions are formed on the OCL to form the concave-convex structure portion 222. In addition to acrylic resin, thermoplastic resin such as polystyrene, nylon, or Teflon (registered trademark) or UV curable resin having acrylic resin, epoxy resin, or fluorine resin as a main component may be used.

At this time, a primer layer for increasing an adhesion property or an insulating layer for preventing leakage may be formed between the latent image bearing member 221 and the concave-convex structure portion 222. In the present embodiment, the concave portions are formed on the OCL, but the concave portions may be formed on the charge transport layer 221a of the latent image bearing member 221. The concave-convex structure portion 222 may be coated with a material having high hardness or a dielectric material for scraping prevention, resistance adjustment, or the like.

At this time, it is necessary to form the concave portions using a coat layer that is sufficiently thin to remain. In the present embodiment, the OPC photosensitive drum is used as the latent image bearing member 221, but a photosensitive drum such as an amorphous silicon photosensitive drum or a photosensitive belt may be used. Besides the photosensitive drum and the photosensitive belt, a so-called electrode drum or an electrode belt in which an electrode is arranged on a drum or a belt may be used. The latent image bearing member will be described later in detail.

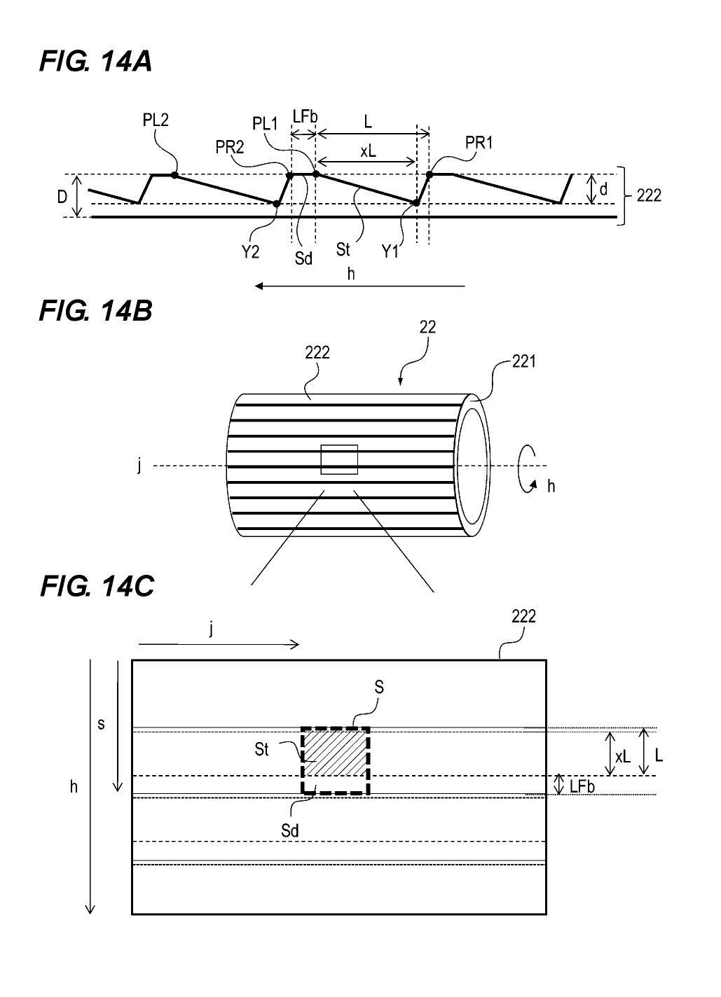

FIG. 4B is a cross-sectional view the concave-convex structure portion 222. The concave portion St according to the present embodiment has a concave-convex shape having inclinations of different angles so that a maximum inclination κL of a moderate slope surface SL of a region PLY between an apex PL and a bottom point Y with respect to the apex PL and a maximum inclination κR of a steep slope surface SR of a region PRY between an apex PR and the bottom point Y with respect to the apex PR satisfy a relation of |κL|<|κR|, and the concave-convex structure portion 222 is formed by a plurality of grooves in which the concave portions St (see FIG. 14 as well) are regularly arranged in the rotation direction h with a period L.

Preferably, |κL| is 0.5 or less, and |κR| is 1.0 or more. Thus, the toner is easily contained on the steep slope surface SR, and a coating property is improved. Further, the toner easily rotates on the moderate slope surface SL due to a couple of force, and thus it is possible to collect the toner even through a small difference of potential. The details will be described later. Hereinafter, a surface having a smaller maximum inclination is referred to as a “moderate slope surface SL,” and a surface having a larger maximum inclination is referred to as a “steep slope surface SR.”

In the present embodiment, the period L is 6.5 μm, a width xL of the moderate slope surface SL is 5.6 μm, a depth d of the moderate slope surface SL is 1.1 μm, the maximum inclination κR of the steep slope surface SR is 1.2, and the maximum inclination κL of the moderate slope surface SL is 0.20. A thickness D of the concave-convex structure portion 222 is 5 μm. In the present embodiment, the concave portion St is substantially parallel to the rotating shaft j but may be inclined. The present invention is not limited to the concave portion St, and a structure corresponding to a determination method which will be described later is included in the present invention. In the present invention, a detailed forming method and a determination method of the concave-convex structure portion 222 will be described later.

Referring back to FIG. 2A, the regulating member 27 is made of a metallic thin plate, and forms abutting pressure using elasticity of a thin plate spring, and the surface of the metallic thin plate comes into contact with or abuts on the toner and the developer bearing member 22. As a material of the metallic thin plate, a thin plate of stainless steel, phosphor bronze, or the like can be used, but in the present embodiment, a phosphor bronze thin plate having a thickness of 0.1 mm was used. In order to improve charging property or fluidity, the thin plate may be coated with resin or the like. A predetermined voltage may be applied to the regulating member 27.

The toner collecting member 24 is configured such that a cylindrical member 241 made of a metallic material is covered with an elastic layer 242. The cylindrical member 241 is formed of any material having conductivity and stiffness, SUS, iron, aluminum, or the like. The elastic layer 242 is formed of a rubber material having elasticity such as silicone rubber, acrylic rubber, nitrile rubber, urethane rubber, ethylene propylene rubber, isopropylene rubber, styrene-butadiene rubber, or fluorine-contained rubber.

A resistance or a surface shape may be controlled by adding functional particles such as carbon, a titanium oxide, metallic particles, or spherical resin to the rubber material as necessary. Further, surface hardness, a resistance, or the like may be adjusted by forming a coating layer on the elastic layer 242. In the present embodiment, the elastic layer 242 made of fluorine-contained rubber is formed on the cylindrical member 241 made of stainless steel. In the present embodiment, a roller-shaped member is used as the toner collecting member 24, but a belt-shaped member may be used.

The toner collecting member 24 is arranged to come into contact with the developer bearing member 22, and rotates in the same direction as the rotation direction h of the developer bearing member 22 in a toner collecting portion in which the toner collecting member 24 and the developer bearing member 22 face each other. A voltage is applied from a power source (not illustrated) to the toner collecting member 24, a difference of potential is formed between the developer bearing member 22 and the toner collecting member 24, and the toner of the non-image portion on the developer bearing member 22 is collected by the difference of potential. In the present embodiment, a DC voltage of −200 V is applied.

Similarly to the developer supply member 23, the cleaning member 29 is a member formed of a porous foam material whose surface having elasticity, a so-called brush member in which conductive fiber is formed in a brush form, a magnetic brush member that bears magnetic particles and forms magnetic particles in a magnetic brush form, or the like. The cleaning may be performed by a regulating member abutting the toner collecting member 24. Further, a voltage may be applied to the cleaning member 29, and the toner may be cleaned from the toner collecting member 24 using a difference of potential.

Referring back to FIG. 1, the transfer member 40 may be formed such that a cylindrical member having stiffness is covered with an elastic layer having a sufficient thickness. The transfer member 40 is arranged to come into contact with the developer bearing member 22, and the transfer member 40 is electrically floating. Thus, a non-electrostatic transfer system of so-called pressure transfer is employed, and for example, scattering of the toner by the electrostatic transfer system of the related art is prevented. In the present embodiment, the pressure transfer is used as an example of the non-electrostatic transfer system, but adhesive transfer of controlling adhesive force of a toner or a member by heat, light, or the like may be used.

Further, the electrostatic transfer system of the related art may be used. In this case, in the transfer portion, the toner image is slightly disturbed due to the difference of potential, but it can be much more improved, compared to the configuration of the related art in which the toner image disturbed on the image bearing member is further disturbed in the transfer portion. In the present embodiment, a roller-shaped member is used as the transfer member 40, but a belt-shaped member may be used.

As described above, the developer supply member 23, the toner collecting member 24, and the transfer member 40 are arranged around the developer bearing member 22 including a plurality of concave portions St having the surface which the toner is contactable in order from the upper stream side in the rotation direction h of the developer bearing member 22.

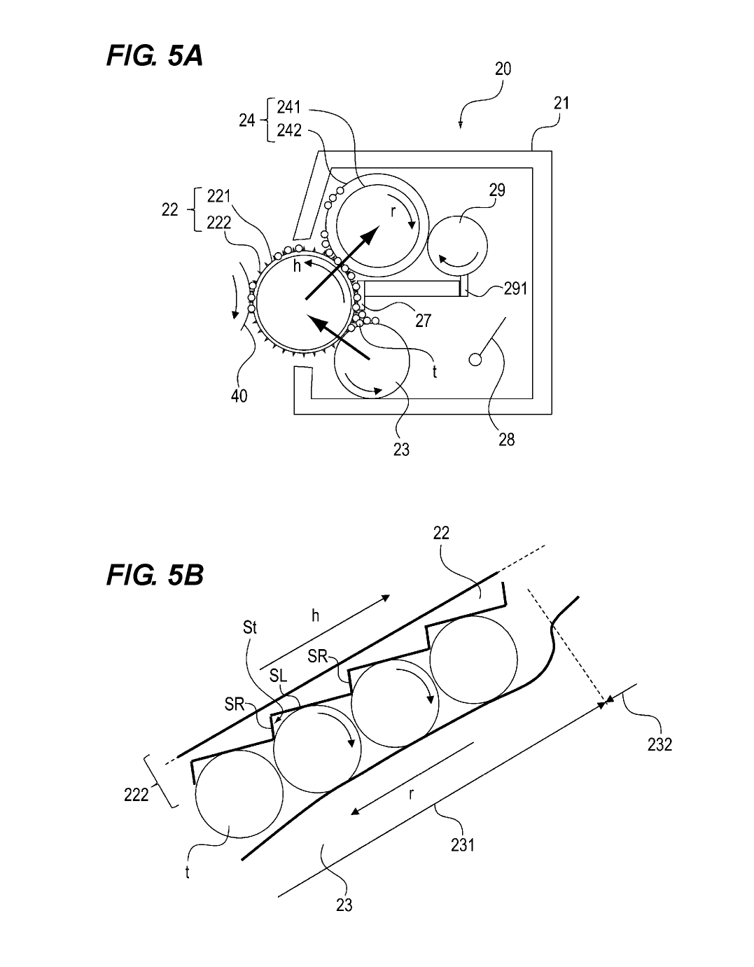

Next, toner coating for the developer bearing member 22 and toner collection by the toner collecting member 24 in the developing apparatus 20 which is one of features of the present invention will be described with reference to FIG. 5A. The toner t is agitated by the agitating member 28 and supplied to the developer supply member 23. The toner t is filled in the foam material on the surface of the developer supply member 23 and conveyed up to the supply portion coming into contact with the developer bearing member 22. In the supply portion, the filled toner t is charged by contact with the developer bearing member 22 and migrates to the developer bearing member 22.

FIG. 5B is a schematic diagram illustrating the supply portion. In the supply portion, the developer supply member 23 rotates in the opposite direction r to the rotation direction h of the developer bearing member 22. For this reason, the toner t filled in the cell 231 on the surface of the developer supply member 23 comes into contact with the concave-convex structure portion 222 of the developer bearing member 22 and is equally stuffed in the direction of the steep slope surface SR. At this time, the toner t is caught on the steep slope surface SR, rotates there in a direction indicated by an arrow, is slide-rubbed, and sufficiently charged.

The toner t comes into contact with the concave portion St of the concave-convex structure portion 222 at multiple points and thus migrates onto the developer bearing member 22 by action of strong electrostatic adhesion force and mechanical adhesion force. At this time, since the width of the cell wall 232 is larger than the width of the concave portion St, the cell wall 232 hardly invades the concave portion St, and the toner on the concave portion St is hardly scrapped. The toner t that has migrated onto the developer bearing member 22 is conveyed up to a regulating portion facing the regulating member 27.

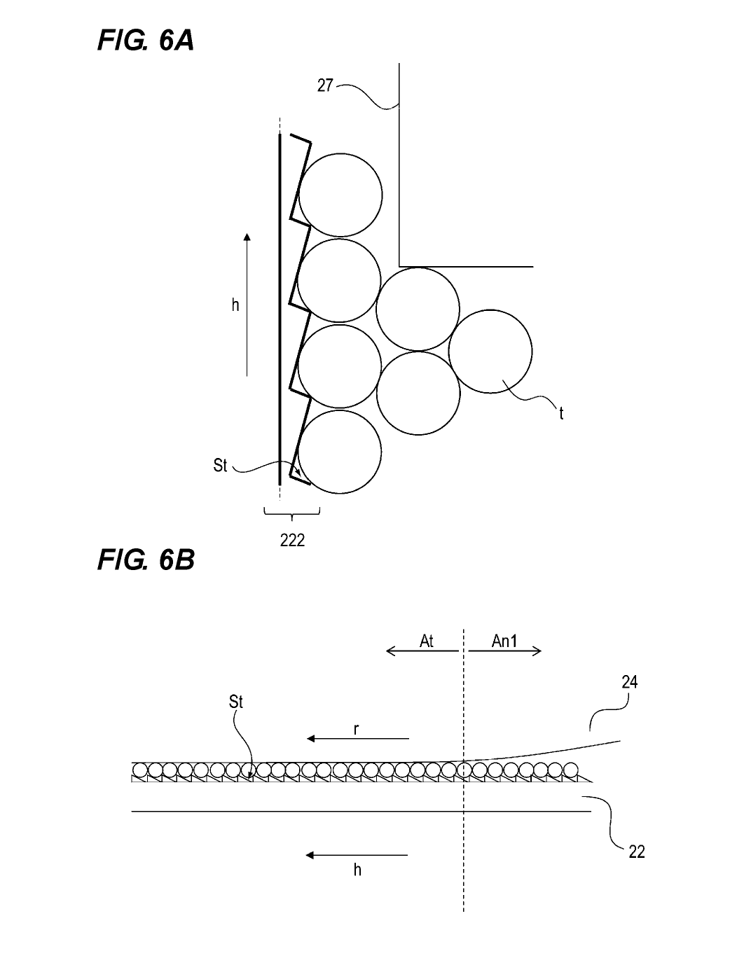

FIG. 6A is a schematic diagram illustrating the regulating portion. In the regulating portion, in addition to the toners that come into contact with and are strongly contained by the concave portions St, there are the toners having two or more layers formed by adhesion force between the toners on the developer bearing member 22. The toners are weaker in force of constraint than the toners coming into contact with the concave portions St, and thus it is possible to selectively regulate the toners through the regulating member 27. At this time, the toner t further slide-rubs the concave portion St and is electrically charged. As a result, the developer bearing member 22 is coated with the high-density thin-layer toner layer along the concave portions St. Thereafter, the toner t on the developer bearing member 22 is conveyed up to a toner collecting portion facing the toner collecting member 24.

FIG. 6B is a schematic diagram illustrating the toner collecting portion. A DC voltage (−200 V) is applied from a power source (not illustrated) to the toner collecting member 24. The difference of potential is formed between the toner collecting member 24 and the latent image formed on the developer bearing member 22, and the toner t of the non-image portion of the surface of the developer bearing member 22 is collected by electrostatic force formed by the difference of potential.

In the present embodiment, the toner collecting member 24 is arranged to come into contact with the developer bearing member 22, and rotates in the same direction r as the rotation direction h of the developer bearing member 22 substantially at an equal velocity. A region in which the developer bearing member 22 and the toner collecting member 24 face each other includes a contact region At in which both members come into contact with each other, a non-contact region An1 immediately before the contact, and a non-contact region An2 (not illustrated) immediately after the contact. The toner t on the developer bearing member 22 is strongly contained by the concave portion St, the toner t invades the contact region At without being disturbed in the non-contact region An1.

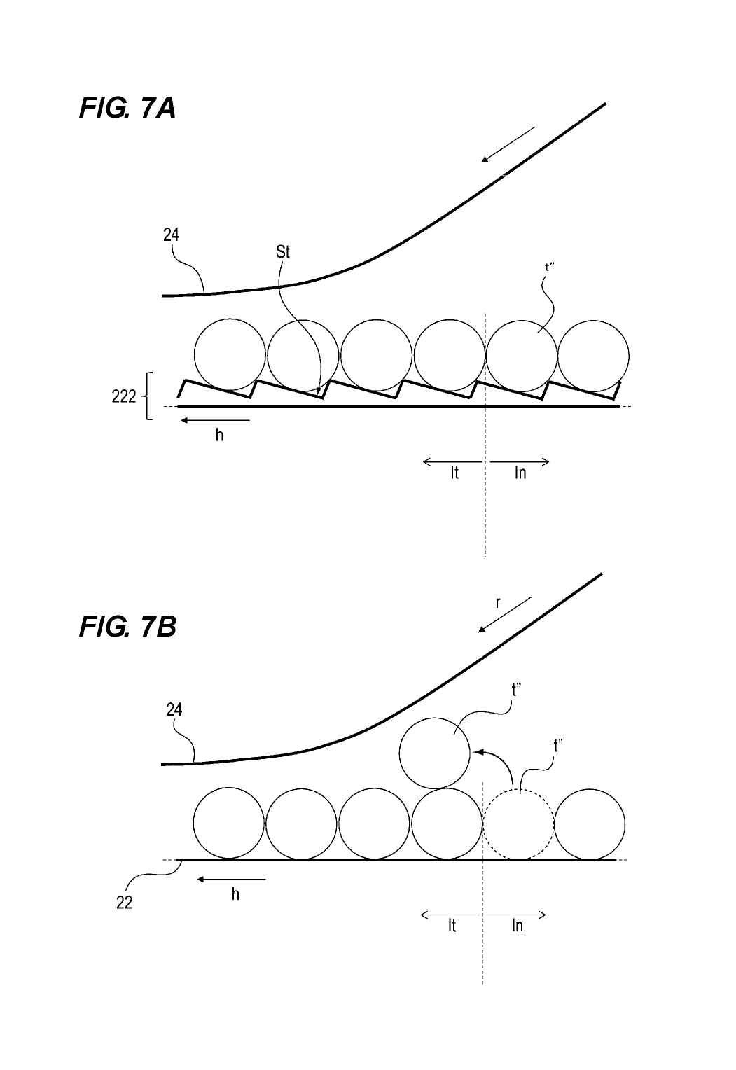

FIG. 7A is a schematic diagram illustrating toner behavior in the non-contact region An1. The latent image is formed on the developer bearing member 22 by a latent image forming method which will be described later, and, for example, a large difference of potential is generated in a boundary between an image portion It and a non-image portion In, and the electric field is applied to the boundary. Thus, force is applied to a toner t″ of the boundary in the non-image portion in a direction of the image portion It, but since the toner t is strongly contained by the concave portion St as described above, the toner t invades the contact region At without being disturbed in the non-contact region An1.

FIG. 7B is a schematic diagram illustrating when there is no concave portion St of the present invention. Since the toner t″ is not constrained structurally, the toner t″ easily undergoes the jumping development in an edge portion of the image portion It due to action of the electric field. As described above, when there is no concave portion St according to the present invention, the toner image is disturbed at the time of coating of the developer bearing member 22 and toner collecting by the toner collecting member 24, and it is difficult to obtain the high-density thin-layer toner image.

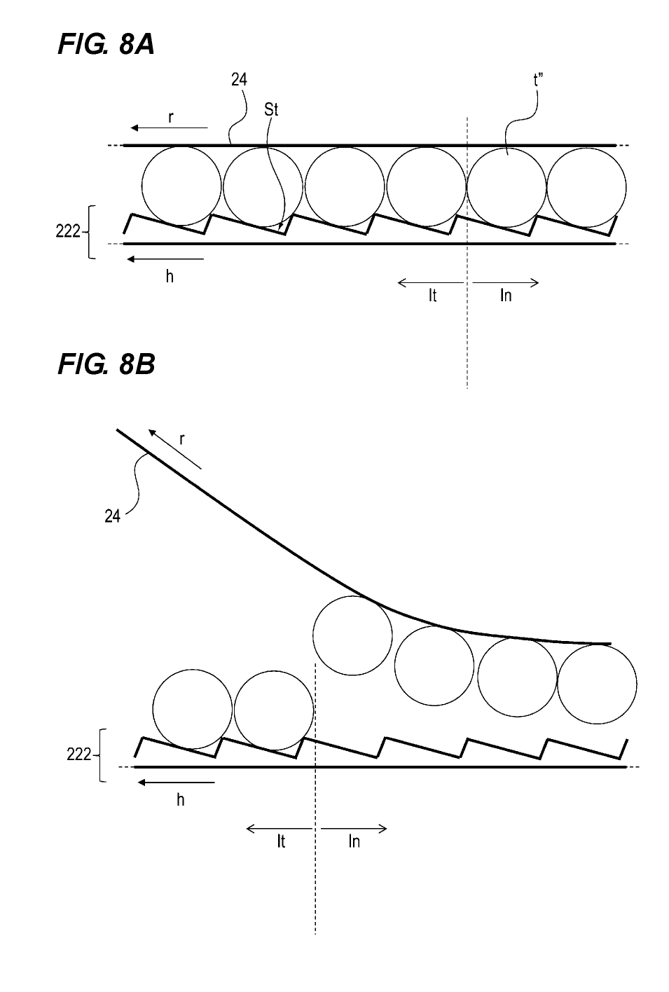

FIG. 8A is a schematic diagram illustrating toner behavior in the contact region At. Since the toner image is not disturbed in the non-contact region An1 as described above, there is a high-density thin layer on the contact region At. Further, since the toner collecting member 24 has elasticity, force according to the latent image equally acts while following small concave-convex portions of the toner layer according to a toner particle size distribution.

FIG. 8B is a schematic diagram illustrating toner behavior in the non-contact region An2. As described above, force acts on the toner on the non-image portion In in the direction of the toner collecting member 24 due to the difference of potential, and thus the toner is collected. On the other hand, force acts on the toner on the image portion It in the direction of the developer bearing member 22 due to the difference of potential, and thus the toner remains on the developer bearing member 22. At this time, the remaining toner image can maintain the high-density thin-layer toner image through the concave portions St. In the present embodiment, the toner collecting member 24 and the developer bearing member 22 rotate at substantially at an equal velocity in the same direction, but a velocity difference may be set.

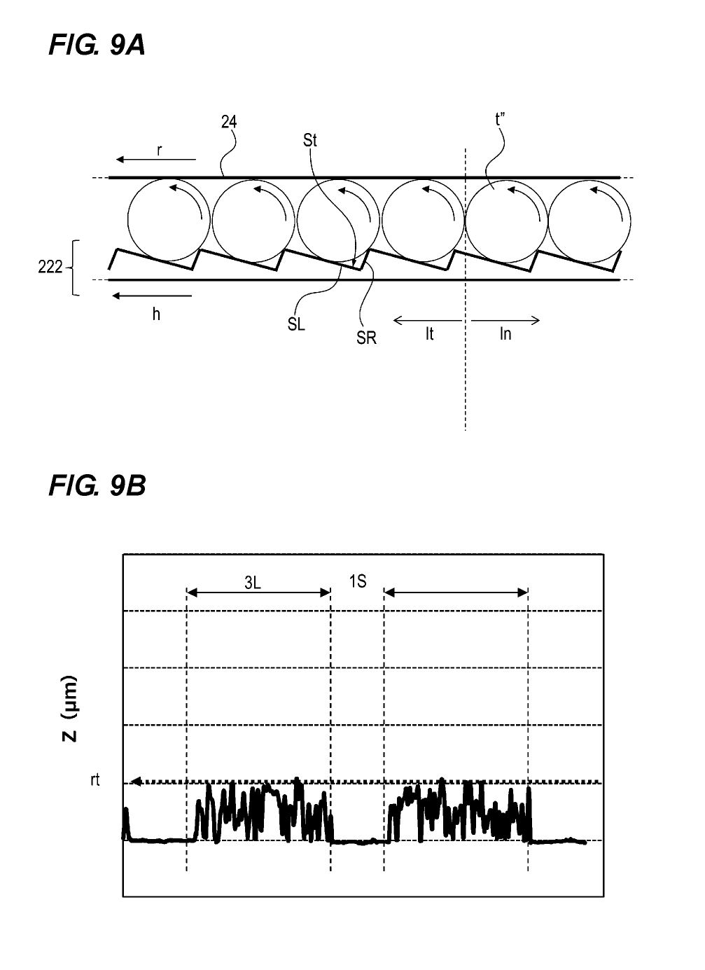

FIG. 9A is a schematic diagram illustrating toner behavior in the contact region At under a condition. At this time, in the concave-convex structure portion 222, it is desirable that a relative velocity of a surface velocity of the toner collecting member 24 to a surface velocity of the developer bearing member 22 be positive when a direction (the direction h in FIG. 9A) in which it gets down the steep slope surface SR and then climbs on the moderate slope surface SL is positive. Due to the relative velocity, a couple of force acts on the toner t in a direction indicated by an arrow in FIG. 9A, the toner t is released from the multi-point contact with the concave portion St, and thus the toner can be collected even by a small difference of potential.

On the other hand, when the relative velocity is set, the toner that has collected once is likely to migrate to the developer bearing member 22 and have two or more layers, and thus it is desirable to suppress the relative velocity. For this reason, a velocity ratio of both surface velocities is preferably set to be 1.1 or less times, more preferably 1.05 or less times. Further, when the velocity ratio is set, by increasing the adhesion force between the toner collecting member 24 and the toner, it is possible to prevent the toner from migrating to the developer bearing member 22 and having two or more layers. Thus, for example, it is possible to suppress the toner from having two or more layers, for example, by decreasing the surface hardness of the toner collecting member 24, increasing a contact area size of the toner collecting member 24 with the toner, and increasing the adhesion force.

The toner collected by the toner collecting member 24 is conveyed up to a cleaning portion facing the cleaning member 29. The cleaning member 29 is a brush member in which conductive fiber is formed in a brush form, and a voltage is applied from a power source (not illustrated) to the cleaning member 29. In the cleaning portion, cleaning is performed by causing the collected toner on the toner collecting member 24 to migrate to the cleaning member 29 through the difference of potential. The cleaned toner is beaten by a metallic plate 291 arranged at the downstream side and dropped, agitated by the agitating member 28 again, and then it is repeated.

FIG. 9B illustrates a profile of a height Z (μm) of the toner layer on the developer bearing member 22 before transfer when a line latent image of 84 μm having 3 lines and a 1 space is developed in the developing apparatus of the present embodiment. A dotted line arrow in FIG. 9B indicates a height rt. rt is an average particle diameter rt of a toner used at this time. A measurement was performed according to an operation manual of a measuring apparatus using a non-contact surface/layer cross section shape measurement system VertScan2.0 (available from Ryoka systems, Inc.).

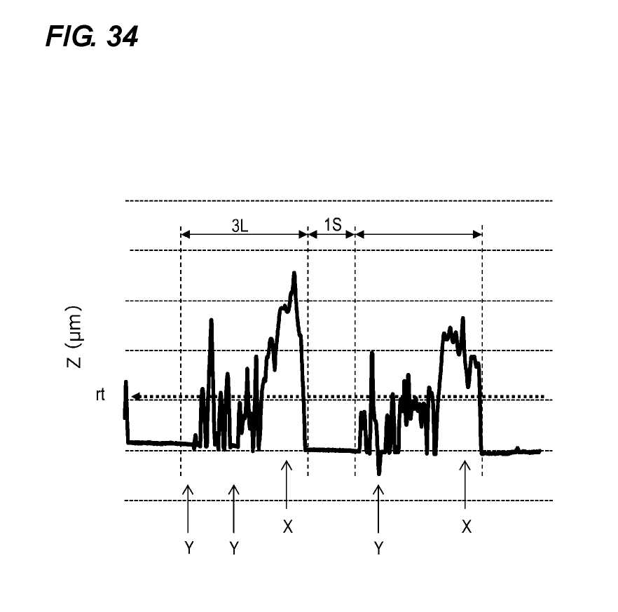

Compared to the toner image (see FIG. 34) output from the existing non-magnetic one-component developing apparatus, the heights of the toner layer in line portions are uniform, and the toner layer is formed of substantially a single layer. In addition, the toner density is also high, and the exposed portions Y in which the surface of the developer bearing member 22 is exposed are not shown. Further, there is little difference in the height of the toner layer and the toner density between lines, and uniformity within the image plane is very high. These features were confirmed, that is, it was confirmed that the high-density thin-layer toner image can be output from a solid portion to a halftone portion and a highlight portion regardless of the latent image pattern.

As described above, according to the developing apparatus 20 of the present invention, non-uniformity of the toner image in the height direction and a reduction in the toner density are solved regardless of the latent image pattern, and a high-quality image can be output with a small toner amount. Further, in the image forming apparatus of the present invention, the image density is decided by area gradation, and thus a stable image system can be constructed.

### <Method of Measuring Average Particle Diameter of Toner>

A toner particle diameter is measured according to an operation manual of a measuring apparatus using a Coulter Multisizer-III (available from Beckman Coulter, Inc.). Specifically, a surfactant of 0.1 g is added to an electrolytic solution 100 ml (ISOTON) as a dispersant, and a measurement sample (toner) of 5 mg is further added. An electrolytic solution in which a sample is suspended undergoes a dispersion process for about two minutes through an ultrasonic dispersion system, and a resulting sample is used as a measurement sample. An aperture is set to 100 μm, the number of samples is measured for each channel, a median size d50 is calculated, and the average particle diameter rₜ of the toner is obtained.

### <Method of Measuring Average Degree of Circularity of Toner>

An equivalent circle diameter, circularity, and a frequency distribution of the toner are measured using an FPIA-2100 model (available from Sysmex Corporation) and calculated using the following Formulas 1 and 2.

[Math. 1]

equivalent circle diameter=(particle projection area/π)^{1/2}×2 (Formula 1)

[Math. 2]

circularity=(boundary length of circle of same area as particle projection area)/(boundary length particle projection image) (Formula 2)

Here, the “particle projection area” is an area of a binary toner image, and the “boundary length of the particle projection image” is defined as a length of a contour line obtained by connecting edge points of the toner image.

In the present invention, the circularity is an index indicating a concave-convex degree of the toner, and indicates 1.00 when the toner has a perfect shape, and as the complexity of the surface shape increases, the value of the circularity decreases. An average degree C. of circularity indicating an average value of a circularity frequency distribution is calculated by the following Formula 3 if circularity (a center value) at a division point i of a particle size distribution is indicated by ci, and the frequency thereof is indicated by fci.

[Math. 3]

average degree C. of circularity=Σᵢ₌₁^{m}(Ci×fci)/Σᵢ₌₁^{m}(fci) (Formula 3)

As a specific measurement method, 10 ml of ion-exchange water from which solid impurities or the like are removed is prepared in a container in advance, a surfactant, preferably, alkyl benzene sulfonate is added as a dispersant, a measurement sample of 0.02 g is further added, and then uniformly dispersed. As a dispersion device, an ultrasonic dispersion system Tetora 150 model (available from Nikkaki Bios Co., Ltd.) is used, a dispersion process is performed for two minutes, and a resulting solution is used as a dispersion liquid. At this time, cooling is appropriately performed so that the temperature of the dispersion liquid is not equal to or higher than 40° C.

The shape of the toner is measured using the FPIA-2100 model, and the dispersion liquid density is adjusted so that the toner density at the time of measurement is 3,000 to 10,000/μl, and 1,000 or more of toners are measured. After the measurement, the average degree of circularity of the toner is obtained using this data.

### <Method of Forming Concave-Convex Structure Portion 222>

The concave-convex structure portion 222 of the developer bearing member 22 may be formed by a thermal nanoimprint technique using thermoplastic resin, an optical nanoimprint technique using light curing resin, a laser edging technique of performing scanning with laser light and performing edging, a diamond edging technique of cutting mechanically using a diamond blade, duplication from those molds using an electroforming technique or the like, or the like.

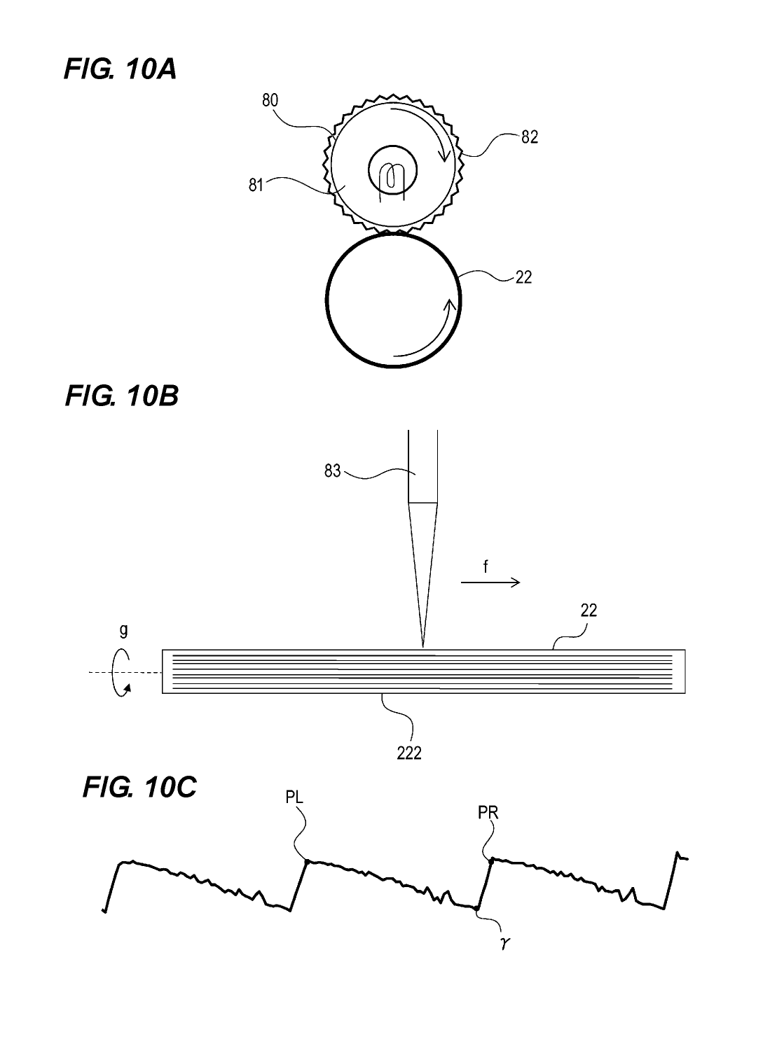

FIG. 10A is a schematic diagram illustrating a forming method using the thermal nanoimprint technique. A film mold 82 of a convex structure having an opposite shape to a desired concave structure is fixed onto a shape transfer roller 80 including a halogen heater 81 therein and caused to come into contact with and be pressurized by the developer bearing member 22. A desired concave-convex structure portion 222 is formed on the developer bearing member 22 by performing heating through the halogen heater 81 within a range of a melting point from a glass-transition temperature while rotating the shape transfer roller 80 and the developer bearing member 22 at an equal velocity.

In the optical nanoimprint technique, a desired concave-convex structure portion 222 is formed such that the surface of the developer bearing member 22 is coated with the light curing resin, irradiated with UV light through a UV light source arranged instead of the halogen heater. At this time, in order to increase an adhesion property between the light curing resin and the developer bearing member 22, surface processing may be performed on the developer bearing member 22, or a primer layer may be formed between the light curing resin and the developer bearing member 22.

FIG. 10B is a schematic diagram illustrating a forming method using the diamond edging technique. The developer bearing member 22 is scanned with a needle 83 having a diamond blade whose leading end has a desired shape in a direction of an arrow f to cut the surface of the developer bearing member 22 mechanically, and thus a descried shape is formed. The concave-convex structure portion 222 is formed by repeating it while rotating the developer bearing member 22 in a direction of an arrow g.

### <Determination Method of Concave-Convex Structure Portion 222>

The determination method of the concave-convex structure portion 222 according to the present invention will be described. The concave-convex structure portion 222 according to the present invention has a structure in which a proportion of the concave portions St which the toner is contactable (which will be described later) per unit area in at least a toner bearing region that bears the toner in the developer bearing member 22 is determined to be 55% or higher. The determination method and the reason will be described below.

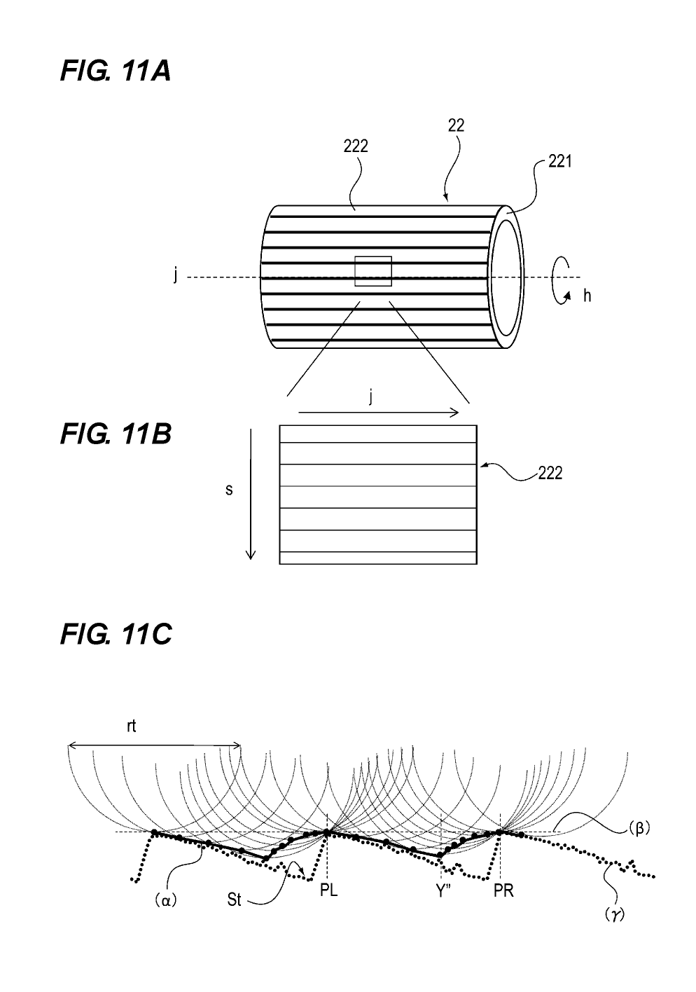

FIG. 11A is a schematic diagram for describing sampling. The sampling is performed such that a surface layer in a central portion of the developer bearing member 22 is cut out using a cutter or a laser and processed to have a smooth sheet shape. Further, instead of performing the sampling, a portion on the developer bearing member 22 may be directly measured, and cylindrical correction may be performed.

FIG. 10C illustrates a shape (γ) of a cross section of the rotating shaft j in a vertical direction s when the shape is measured using the non-contact surface/layer cross section shape measurement system VertScan2.0 (available from Ryoka systems, Inc.). Next, a shape of a designated region is measured using an AFM (Nano-I available from Pacific nanotechnology Inc.).

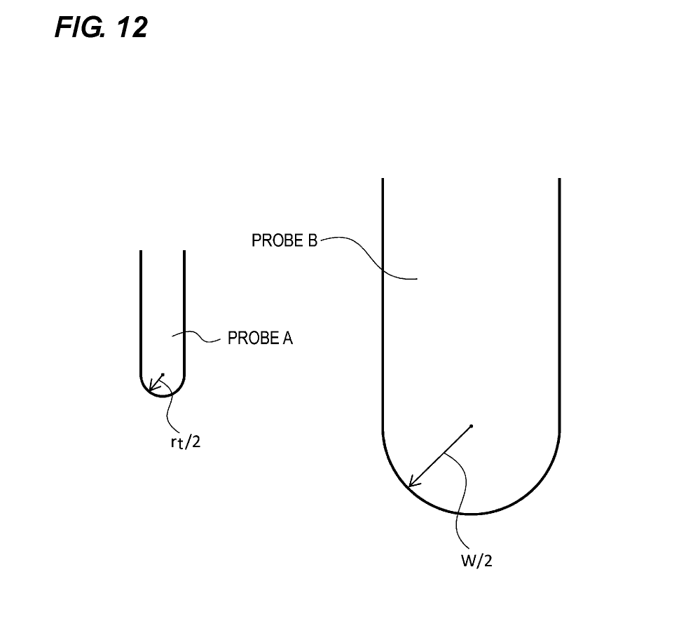

FIGS. 12A and 12B are schematic diagrams of leading end shapes of two types of cantilevers (probes) used at this time. A probe A is a semispherical probe (FIG. 12A) having a leading end corresponding to the toner particle diameter rₜ. A probe B is a semispherical probe (FIG. 12B) having a leading end corresponding to a width W of the cell wall 232 formed on the surface of the developer supply member 23. In the present embodiment, the probe A in which the leading end is a ball of 6.8 μm and the spherical probe B in which the leading end is a ball of 60 μm were used. A method of measuring the width W of the cell wall 232 will be described later.

FIG. 11B illustrates a shape (α and β in FIG. 11C) obtained by scanning the rotating shaft j with the probe in the vertical direction s and measuring the leading end position of each probe, similarly to the measurement of the shape γ. A shape (a solid line of α in FIG. 11C) obtained by measuring a cross section shape (a dotted line of γ in FIG. 11C) through the probe A of the AFM and a shape (a broken line of β in FIG. 11C) obtained by measuring the cross section shape (a dotted line of γ in FIG. 11C) through the probe B are illustrated.

Since the probe A has the size corresponding to the toner particle diameter, the measurement is performed while the probe A invades the concave portion St which the toner is contactable. On the other hand, since the probe B has the size corresponding to the width of the cell wall 232, the probe B hardly invades the concave portion St in which several toners are inserted, and the trajectory of the probe B can be approximated by a straight line passing through the apexes. A difference (β−α) between obtained shapes is obtained, a differential thereof is obtained, and the apexes and the bottom points are decided.

In the present invention, the concave portions St which the toner is contactable have a structure having the following features through the measurement method. A structure between apexes satisfying that “the difference (β−α) between the neighboring apexes obtained by the measurement is rt or less,” and a distance L between the apexes is smaller than 3rt″ is used as the concave portion St according to the present invention. The reason will be described below.

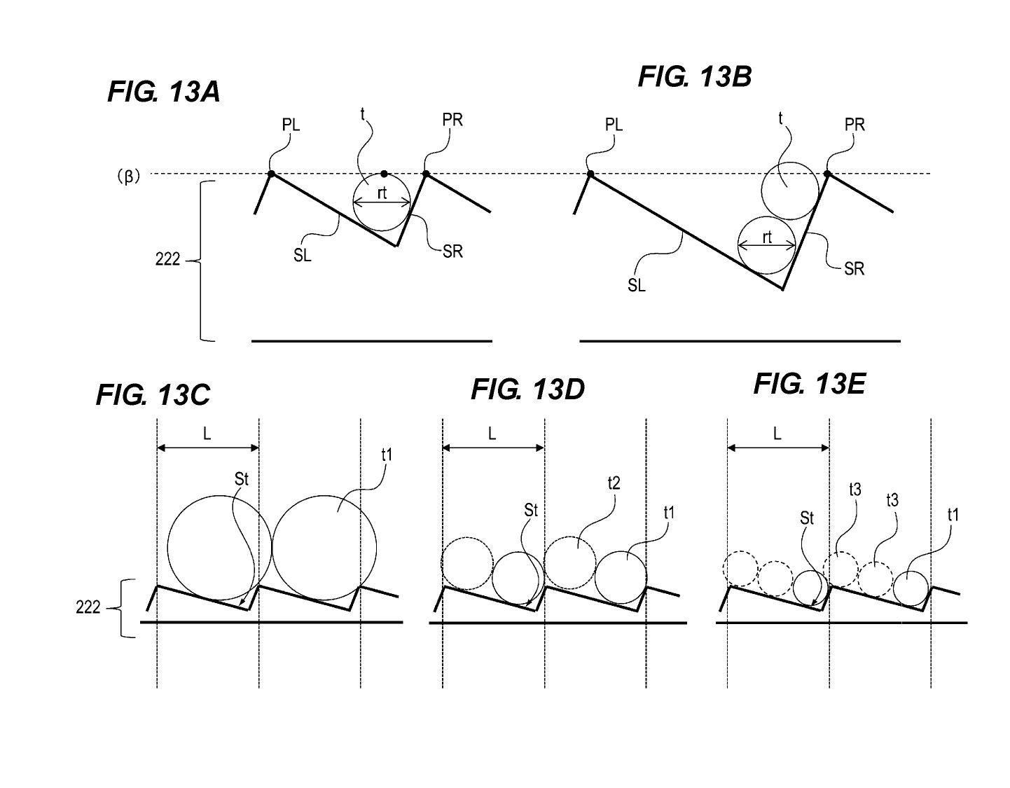

FIGS. 13A and 13B are schematic diagrams illustrating the concave portion St (FIG. 13A) in which the difference (β−α) is rt or less and the concave portion St (FIG. 13B) that does not satisfy the condition. If the difference exceeds rt, the toner has two or more layers in the height direction. Since the toner having two or more layers hardly come into contact with the concave portion St at the multiple points, due to the jumping development or the like, the toner image is likely to be disturbed, and the high-density thin-layer toner image is hardly formed. Due to the above reason, the difference (β−α) is required to be rt or less.

FIGS. 13C, 13D, and 13E are schematic diagrams illustrating the concave portions St when the distance L between the apexes is equal to the toner particle diameter rt (FIG. 13C), when the distance L between the apexes is twice the toner particle diameter rt (FIG. 13D), and the distance L between the apexes is three times the toner particle diameter rt (FIG. 13E). Coating of toners t1 (a solid line circle) that can come into contact with the concave portions St at the multiple points is stably performed. As illustrated in FIG. 13D, since there is a space corresponding to the toner particle diameter rt between the toners t1, it also functions as the concave portion St, and coating of toners t2 is stably performed.

On the other hand, when the distance L between the apexes is three times the toner particle diameter rt as illustrated in FIG. 13E, a toner t3 coated between the toners t1 is not constrained by the concave portion St or between the stable toners t1, and thus coating is not stably performed, and the high-density thin-layer toner image is hardly formed. Due to the above reason, the distance L between the apexes is required to be smaller than 3rt.

The structure having the feature is used as the concave portion St which the toner is contactable according to the present invention, and in the concave-convex structure portion 222 according to the present invention, the proportion of the concave portions St is 55% or higher. The reason will be described below.

FIG. 14A illustrates an example of the concave-convex structure portion 222 according to the present invention. A feature lines in that there is a non-concave portion Sd having a width LFb between the concave portions St between the apexes (for example, between PR1 and PL1 and between PR2 and PL2).

FIG. 14B is a perspective view illustrating the developer bearing member 22. FIG. 14C is a schematic diagram illustrating an upper diagram of the concave-convex structure portion 222 obtained by enlarging a part of the developer bearing member 22 of FIG. 14B. A region S (a broken line in FIG. 14C) including the concave portion St and the non-concave portion Sd on the concave-convex structure portion 222, the concave portion St in the region S, and the non-concave portion Sd in the region S are illustrated. As described above, the concave portion St is coated with the toner, and then the toner is transferred and fixed onto the transfer material 60 through the toner collecting process and the transfer process. Here, the toner amount necessary for the image portion is an amount in which it is possible to cause the toners to adhere to each other with no gap after the fixing and cover the transfer material 60 with the toner image. Specifically, a total volume of the toner with which the concave portion St is coated is equal to or more than a volume of a cube decided by the product of an area Sa of the region S and a thickness dt of the toner layer after the fixing.

$$\begin{matrix}( Formula 4 ) & \\ \frac{Sta \cdot κ}{ρ} \geq Sa \cdot d t & [ Math . 4 ]\end{matrix}$$

(Sta is an area (cm²) of the concave portion St, Sa is an area (cm²) of the region S, ρ is a toner true specific gravity (g/cm³), dt is a thickness (cm) of the toner layer after the fixing, and κ is a toner amount (g/cm²) in the concave portion St)

The toner amount κ in the concave portion St can be approximated by the following Formula 5 since it is most densely filled with the toner.

$$\begin{matrix}( Formula 5 ) & \\ κ = \frac{π \cdot ρ \cdot rt}{3 \sqrt{3}} \times {10}^{- 4} & [ Math . 5 ]\end{matrix}$$

The thickness dt of the toner layer after the fixing can be approximated by the following Formula 6 from the two Formulas since up to ⅓ of the toner particle diameter rt can be crushed under a general fixing condition.

$$\begin{matrix}( Formula 6 ) & \\ \frac{Sta}{Sa} \geq 0.55 & [ Math . 6 ]\end{matrix}$$

In other words, when the proportion of the concave portions St in the concave-convex structure portion 222 is 55% or higher, it is possible to fix the toner with no gap. Due to the above reason, in the concave-convex structure portion 222 according to the present invention, the proportion of the concave portions St which the toner is contactable is required to be 55% or higher.

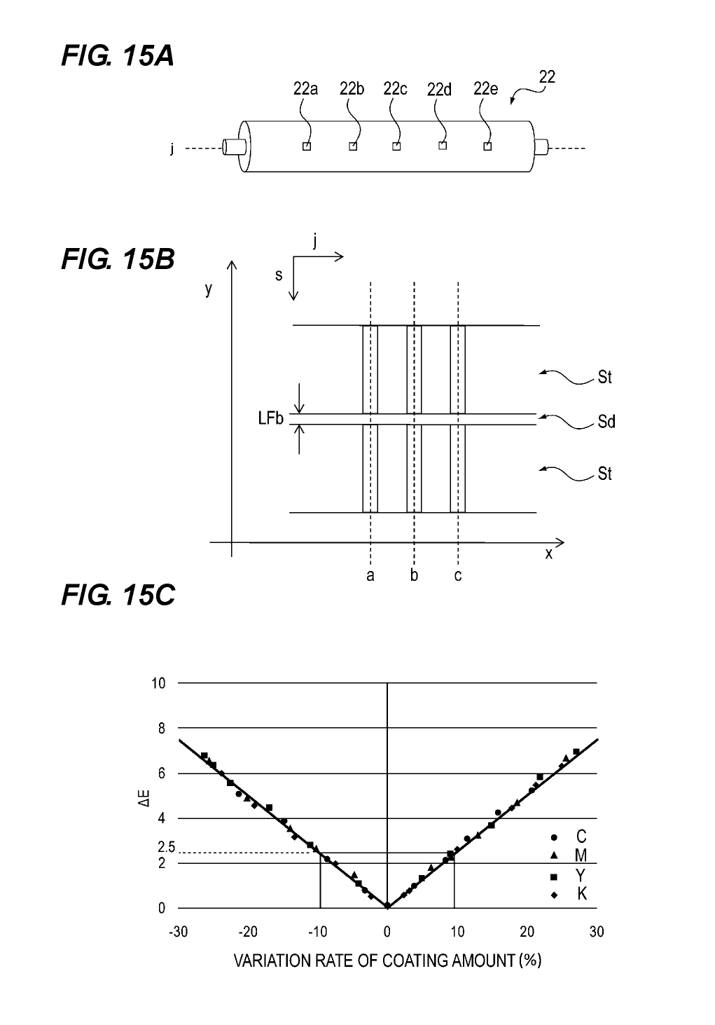

Next, the determination method of the concave-convex structure portion 222 according to the present invention will be described in detail. FIG. 15A is a schematic diagram illustrating the developer bearing member 22. Five arbitrary surface layer surfaces (22a, 22b, 22c, 22d, and 22e) are cut out from the region bearing the toner in the direction of the rotating shaft j, and the surface layer surfaces (68 μm×68 μm) having a length that is 10 times the toner particle diameter as one side are measured at observation points (22a, 22b, 22c, 22d, and 22e). As described above, the scanning by the probes A and B is performed in the vertical direction s, and shapes (x, y, zA) and (x, y, zB) of the surface layer surfaces are measured. The apexes and the depths of the concave portions St are measured based on the difference (zB−zA) between the measured shapes in the height direction, and the concave portions St satisfying a determination criteria are extracted.

FIG. 15B illustrates a result of extracting the concave portions St (painted portions) when the surface layer surface is scanned (broken lines a, b, and c) with the probe in the vertical direction s. The proportions of the respective concave portions St in the surface layer surfaces (22a, 22b, 22c, 22d, and 22e) are obtained, and an average value thereof is obtained and used as the proportion of the concave portions St. When the proportion of the concave portions St is calculated to be 55% or higher, it is the concave-convex structure portion 222 of the present invention. It is determined to be the developer bearing member 22. A structure that is determined not to be the concave portion St according to the measurement criteria, for example, a tiny structure that is hardly tracked by the probe A, a structure having a short period, a structure having a long period that can be tracked by the probe B, or the like has no influence on the problem of the present invention and thus may be included in the concave-convex structure portion 222.

Further, it is desirable to suppress a variation rate of the proportion of the concave portions St in the concave-convex structure portion 222 to be less than ±10%. The reason will be described below. FIG. 15C illustrates a relation between a variation rate of a coating amount and a color difference ΔE of the developer bearing member 22. A relation between the variation rate of the coating amount and the color difference ΔE when the developing roller is coated with each of toners of cyan (C), magenta (M), yellow (Y), and black (K) by 0.4 mg/cm² is illustrated as a reference.

When the coating amount is increased from the reference (0.4 mg/cm²) by 10%, ΔE is changed by 2.5, and when the coating amount is decreased by 10%, ΔE is changed by 2.5. Thus, in order to suppress the in-plane color difference ΔE to be less than 5 for all colors, it is necessary to suppress the variation rate of the coating amount to be less than ±10%. Further, in order to suppress the in-plane color difference ΔE to be less than 3, it is desirable to suppress the variation rate of the coating amount to be less than ±6%.

On the other hand, since the coating amount in proportion to the proportion of the concave portions St, in order to suppress the variation rate of the coating amount on the concave-convex structure portion 222 to be less than ±10%, the variation rate of the proportion of the concave portions St is required to be suppressed to be less than ±10%. For the variation rate, a minimum value Mn and a maximum value Mx of the proportion of the concave portions St on the five surface layer surfaces (22a, 22b, 22c, 22d, and 22e) are obtained, and a rate (=±Δ/Av×100%) of a variation Δ (=Mx−Av) from an average value Av to the average value Av is used.

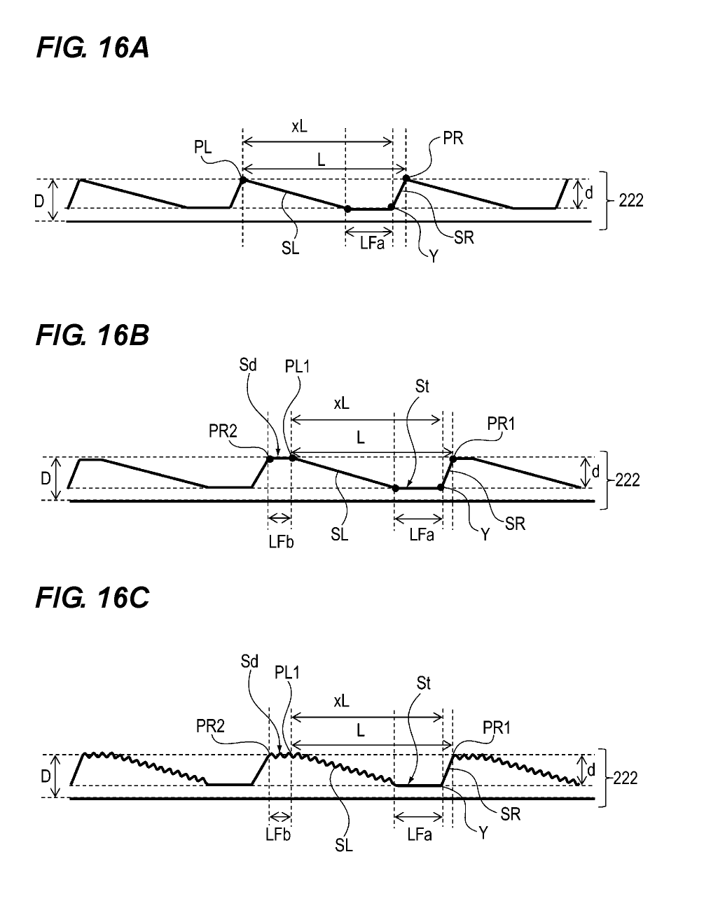

The concave-convex structure portion 222 of the present invention that satisfies the determination criteria is included here in addition to (FIG. 4B and FIG. 14A). FIGS. 16A to 16D are schematic diagrams illustrating examples of the structure portion according to the present invention. Similarly to the structure portion, it is a structure including a plurality of grooves formed substantially in parallel to the rotating shaft j, a cross-sectional shape of the groove is a concave-convex shape having inclinations of different angles, and the steep slope surface SR and the moderate slope surface SL have a plurality of inclinations. In FIG. 16A, a flat portion (a portion having a width LFa) is formed on the moderate slope surface SL, and thus fine toners hardly remain in the concave portion St, and the toner fusion and the like can be improved. In FIG. 16B, there is a non-concave portion Sd having a width LFb between the concave portions St of FIG. 16A.

By forming the flat non-concave portion Sd, it is possible to prevent the shape from being changed due to abrasion caused by slide-rubbing with the developer or the toner collecting member. At this time, the width LFb of the non-concave portion Sd is preferably smaller than the toner particle diameter rt. Thus, the toner with which the non-concave portion Sd is coated is confined, and it is possible to coat the developer bearing member 22 with a stable amount of toner.

In FIG. 16C, surface roughness of a part of the moderate slope surface SL of FIG. 16B is larger than that of the steep slope surface SR. Thus, the adhesion force between the moderate slope surface SL and the toner is decreased, and it is possible to improve the toner collection property of the toner collecting member while maintaining the coating property for the developer bearing member 22.

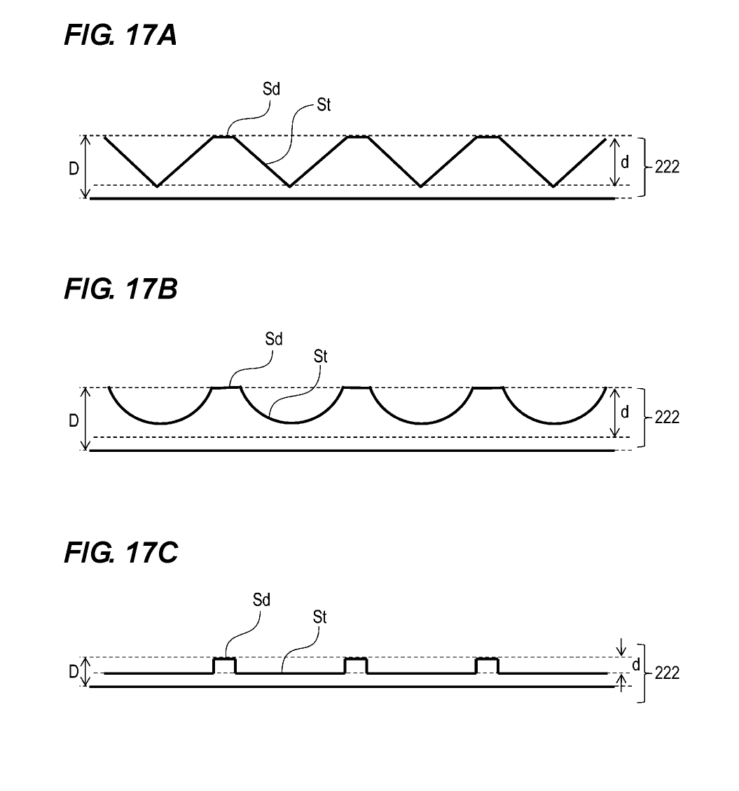

FIGS. 17A to 17C are schematic diagrams illustrating examples of the concave-convex structure portion according to the present invention. Similarly to the structure portion, it is a structure including a plurality of grooves formed substantially in parallel to the rotating shaft j, and cross-sectional shapes of the grooves are a V shape (FIG. 17A), a semicircular shape (FIG. 17B), and a rectangular shape (FIG. 17C). Besides these shapes, it may be a combination of inclined shapes or a shape in which the presence or absence of the non-concave portion Sd is varied. As described above, it may be a structure including a plurality of isolated concave portions St in addition to grooves extending in the rotating shaft j.

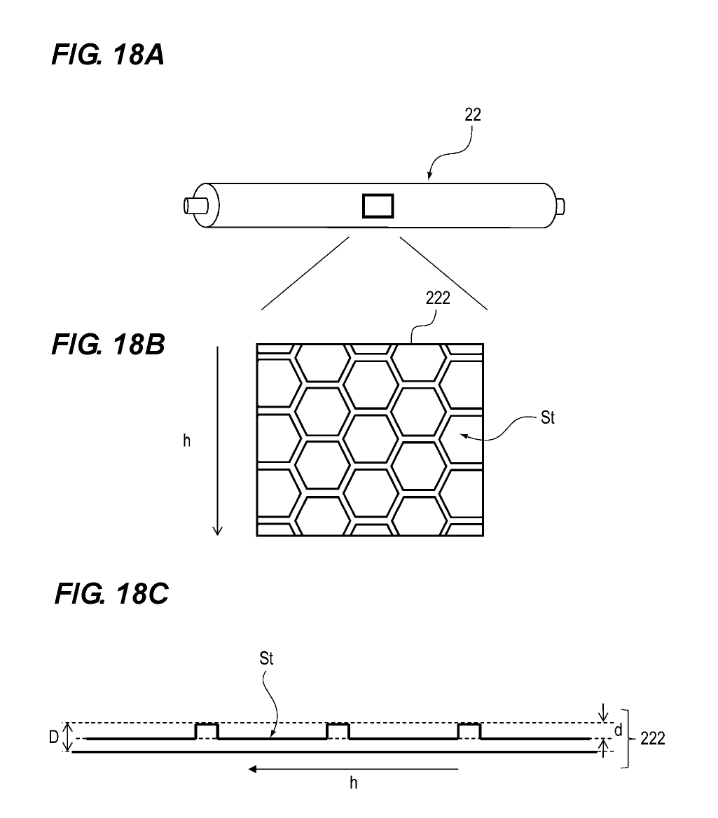

FIG. 18A is a schematic diagram illustrating an example of the concave-convex structure. FIG. 18B is an enlarged plane view of the developer bearing member 22, and FIG. 18C is a cross-sectional view of FIG. 18B. A structure has a honeycomb shape in which a plurality of hexagonal concave portions St is uniformly arranged. The shape of the concave portion St may not be a hexagonal shape, and a cross sectional shape may be a circular lens array shape, a V shape, a concave-convex shape having a different inclination, or the like, similarly to the groove. Like a structure, in addition to the structure in which the concave portions St are uniformly arranged, it may be a structure in which the concave portions St are non-uniformly arranged. In the above structure portions, it is desirable that the proportion of the concave portions St which the toner is contactable be 55% or higher, and the variation rate of the proportion of the concave portions St be less than ±10%.

### <Method of Measuring Width W of Cell Wall 232>

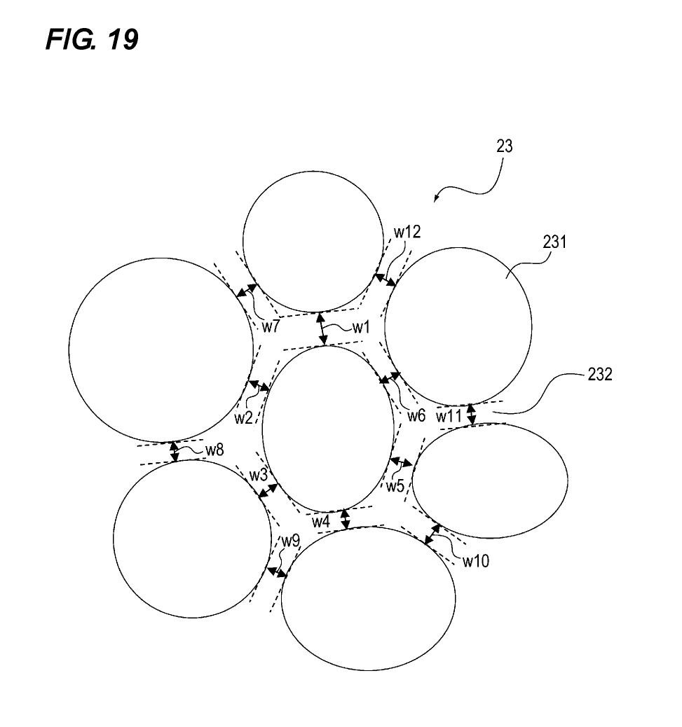

The surface of the developer supply member 23 is photographed by a microscope (VHX-5000 available from Keyence Corporation), and the width of the cell wall 232 is measured. FIG. 19 is a schematic diagram illustrating the surface of the developer supply member 23. Specifically, seven neighboring cells 231 are photographed at arbitrary positions of the central portion of the developer supply member 23. For the photographed image, distances w (w1 to w12) of closest approach of the cells 231 are measured according to the operation manual of the measuring apparatus, and an average value is used as the width W of the cell wall 232.

### <Latent Image Forming Method>

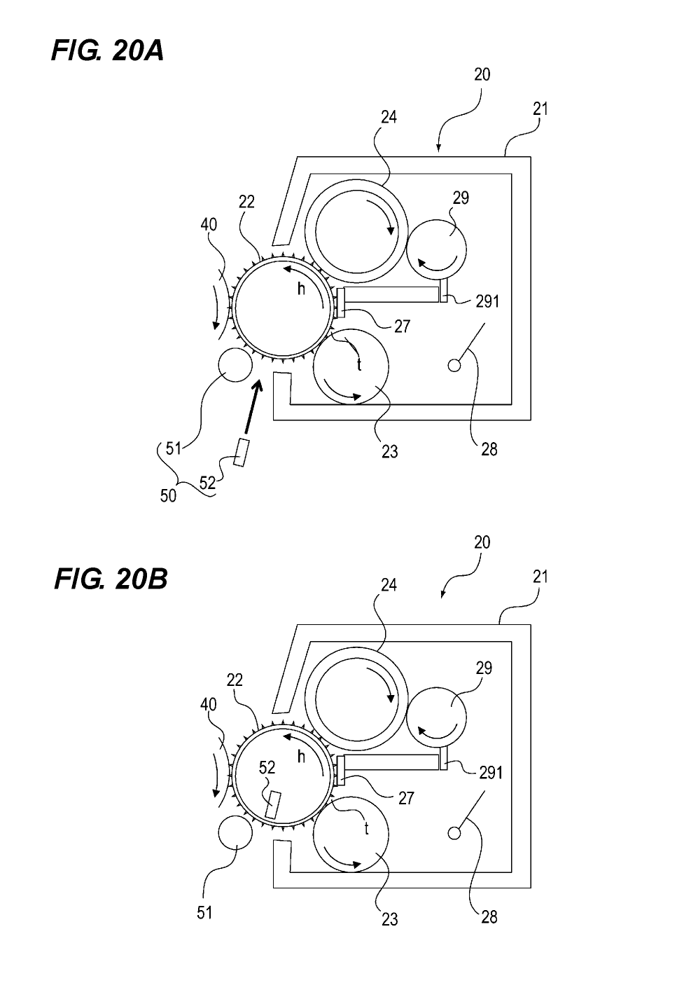

The latent image forming method according to the present invention will be described. FIG. 20A is a schematic configuration diagram illustrating an embodiment of the image forming apparatus of the present invention. The latent image forming member 50 serving as a latent image forming apparatus that forms an electrostatic latent image on the developer bearing member 22 includes a charging apparatus 51 and an exposure apparatus 52. As the charging apparatus 51, in addition to a general corona charging apparatus and a roller charging apparatus, for example, an injection charging apparatus that directly injects charges through conductive magnetic particles or the like is used. As the exposure apparatus 52, a laser modulator, an LED head array, or the like is used.

In the present embodiment, charging to −450 V was performed through the corona charging apparatus, a bright potential was adjusted to be attenuated to −100 V through the laser modulator, and a line latent image was formed under a condition. Before the developer bearing member 22 is coated with the toner, the charging apparatus 51 and the exposure apparatus 52, that is, the transfer member 40, the charging apparatus 51, the exposure apparatus 52, and the developer supply member 23 are arranged in the described order from the upstream side in the rotation direction h of the developer bearing member 22. At this time, a cleaning member for cleaning the transfer toner residue may be arranged between the transfer member 40 and the charging apparatus 51.

FIG. 20B is a schematic configuration diagram illustrating an embodiment of the image forming apparatus of the present invention. An array type exposure apparatus 52 is arranged in the developer bearing member 22, and a latent image is formed by a so-called back exposure system that forms a latent image using light from an inner wall. For this reason, the drum supporting member 221e of the developer bearing member 22 is a transparent supporting member such as a drum supporting member made of glass, and a transparent electrode layer such as an indium tin oxide (ITO) is formed thereon, and a photo conductor layer such as a CGL or a CTL is stacked thereon.

Because of the back exposure system, light permeability of the concave-convex structure portion 222 is not required, and a light impermeable material may be used. An arrangement position of the exposure apparatus is not limited as long as the exposure apparatus is arranged between the transfer member 40 and the toner collecting member 24. In other words, the transfer member 40, the charging apparatus 51, the exposure apparatus 52, the developer supply member 23, and the toner collecting member 24 or the transfer member 40, the charging apparatus 51, the developer supply member 23, the exposure apparatus 52, and the toner collecting member 24 are arranged in the described order from the upstream side in the rotation direction h of the developer bearing member 22. At this time, a cleaning member for cleaning the transfer toner residue may be arranged between the transfer member 40 and the charging apparatus 51.

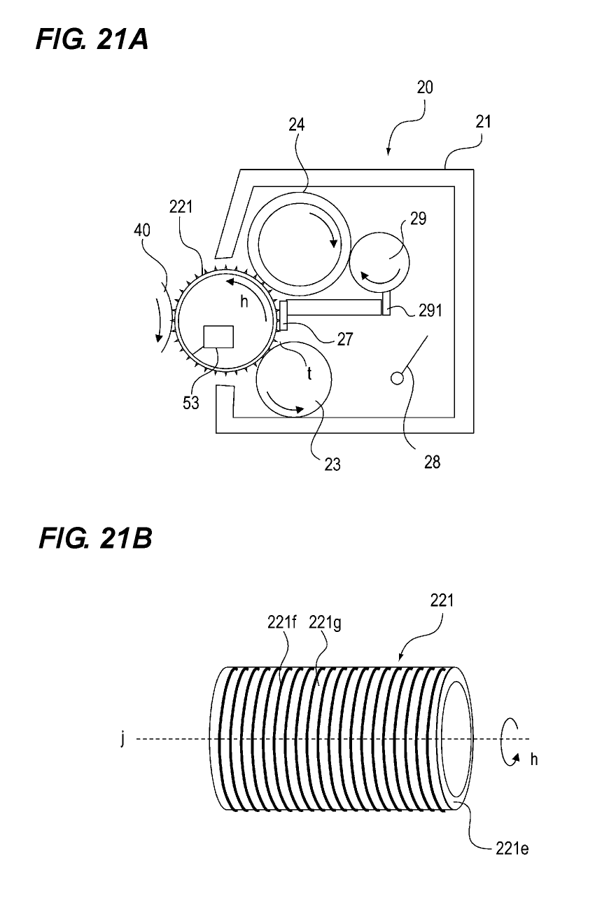

FIG. 21A is a schematic configuration diagram illustrating an embodiment of the image forming apparatus of the present invention. A latent image is formed by a so-called electrode drum that forms a latent image by applying a voltage to an electrode portion on the latent image bearing member 221 through a voltage control apparatus 53.

FIG. 21B is a schematic diagram illustrating the latent image bearing member 221 configuring the developer bearing member 22. The latent image bearing member 221 serving as the “developer bearing member” mainly includes a drum supporting member 221e, an electrode portion 221f formed thereon, an insulating portion 221g, and the voltage control apparatus 53 that is arranged in a hollow portion of the drum supporting member 221e, applies a voltage to the electrode portion 221f, and controls the applied voltage. A plurality of electrode portions 221f is formed in a circumferential direction. At this time, electrodes extending in the circumferential direction may be connected to be endless or may be formed as electrodes in which a plurality of arcs is independent.

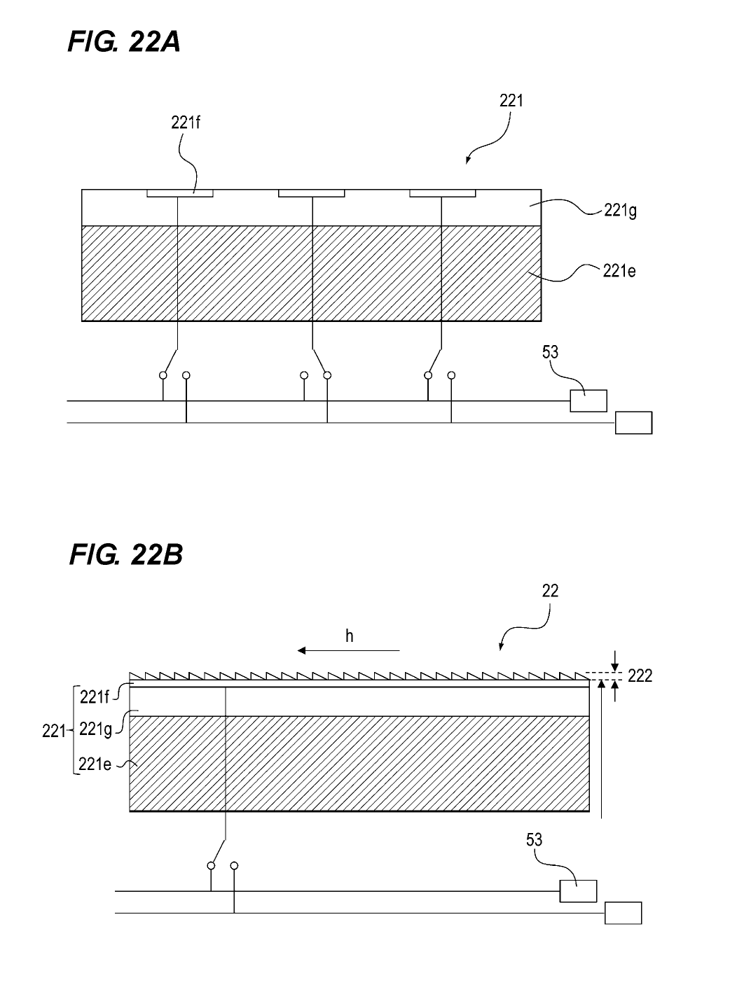

FIG. 22A is a schematic diagram illustrating a cross section of the latent image bearing member 221 in the direction of the rotating shaft j. The insulating portion 221g and the electrode portion 221f are formed on the drum supporting member 221e, and the electrode portion 221f may be electrically connected with the voltage control apparatus 53. As a manufacturing method, respective layers are stacked and formed using a photolithography technique.

FIG. 22B is a schematic diagram illustrating a cross section of the developer bearing member 22 in the circumferential direction. The concave-convex structure portion 222 made of dielectric material is formed on the latent image bearing member 221. Similarly to the back exposure system, the light permeability of the concave-convex structure portion 222 is not required, and a light impermeable material may be used.

### Second Embodiment

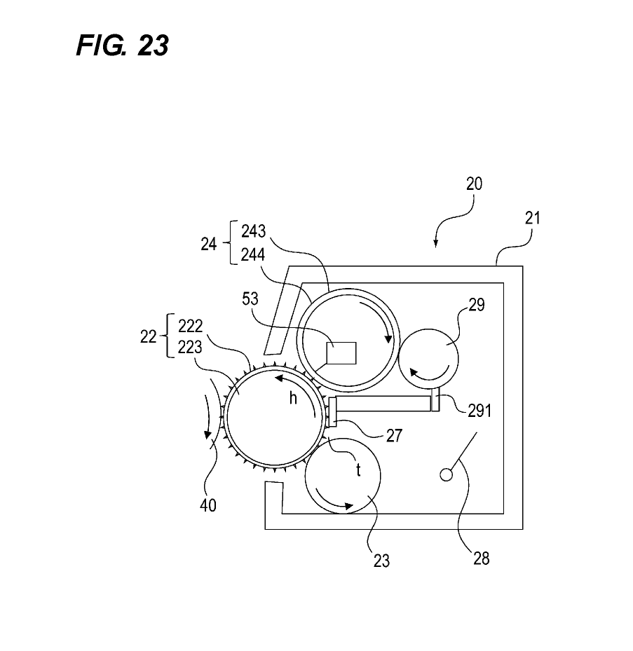

FIG. 23 is a schematic configuration diagram illustrating an image forming apparatus according to a second embodiment of the present invention. In the first embodiment, the developer bearing member 22 bears the latent image, whereas in the present embodiment, the toner collecting member 24 bears the electrostatic image. Even when the toner collecting member 24 is set to bear the electrostatic image, the toner image corresponding thereto is formed on the developer bearing member 22. By bearing the latent image through the toner collecting member 24, the restriction of the light permeability in the concave-convex structure portion 222 of the developer bearing member 22 is reduced, and selectivity of a material or a shape is increased. The electrode drum configuration is described as an example of the toner collecting member 24, but the latent image may be formed on a photosensitive drum or a photosensitive belt using a charging apparatus and an exposure apparatus.

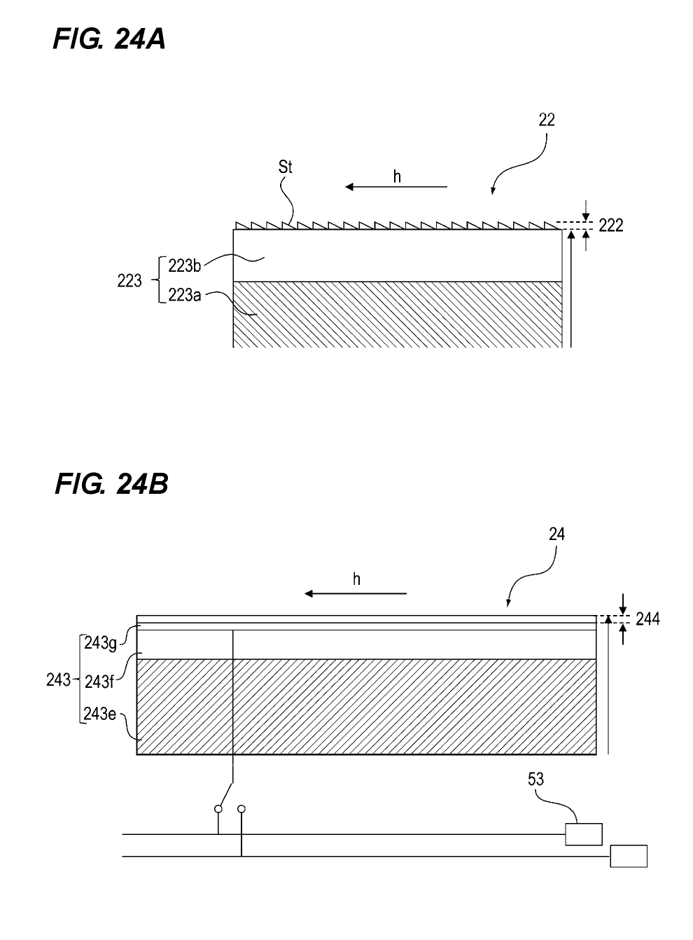

FIG. 24A is a schematic diagram illustrating a cross section of the developer bearing member 22. The developer bearing member 22 includes an elasticity member 223 and a concave-convex structure portion 222 including a plurality of concave portions St having a surface which the toner is contactable. The elasticity member 223 is formed such that a cylindrical member 223a made of a metallic material is covered with an elastic layer 223b. The cylindrical member 223a is formed of any material having conductivity and stiffness such as SUS, iron, aluminum, or the like. The elastic layer 223b is formed of a rubber material having elasticity such as silicone rubber, acrylic rubber, nitrile rubber, urethane rubber, ethylene propylene rubber, isopropylene rubber, styrene-butadiene rubber, or fluorine-contained rubber.

A resistance or a surface shape may be controlled by adding functional particles such as carbon, a titanium oxide, metallic particles, or spherical resin to the rubber material as necessary. Further, the concave-convex structure portion 222 is formed above the elastic layer 223b. The concave-convex structure portion 222 is made of thermoplastic resin such as acrylic, polystyrene, nylon, or Teflon (registered trademark) or UV curable resin having acrylic resin, epoxy resin, or fluorine resin as a main component.

At this time, for example, a primer layer for increasing an adhesion property may be formed between the elastic layer 223b and the concave-convex structure portion 222. A concave portion may be formed directly on the elastic layer 223b. At this time, the elastic layer 223b may be coated with a material having high hardness or an insulating material for scraping prevention or an insulation treatment.

FIG. 24B is a schematic diagram illustrating a cross section of the toner collecting member 24. The toner collecting member 24 includes a latent image bearing member 243 and a dielectric layer 244. The latent image bearing member 243 includes a drum supporting member 243e, an electrode portion 243f formed thereon, an insulating portion 243g, and a voltage control apparatus 53 that is arranged in a hollow portion of the drum supporting member 243e, applies a voltage to the electrode portion 243f, and controls the applied voltage. A dielectric layer 244 is formed on the latent image bearing member 243 for preventing scraping or a leakage.

In the present embodiment, the electrode drum configuration is described as an example of the toner collecting member 24, but the latent image may be formed on a photosensitive drum or a photosensitive belt using an charging apparatus and an exposure apparatus. Except the members described above, a detailed description of the toner coating for the developer bearing member 22 and the toner collection by the toner collecting member 24 which are the same as in the first embodiment is omitted.

### Third Embodiment

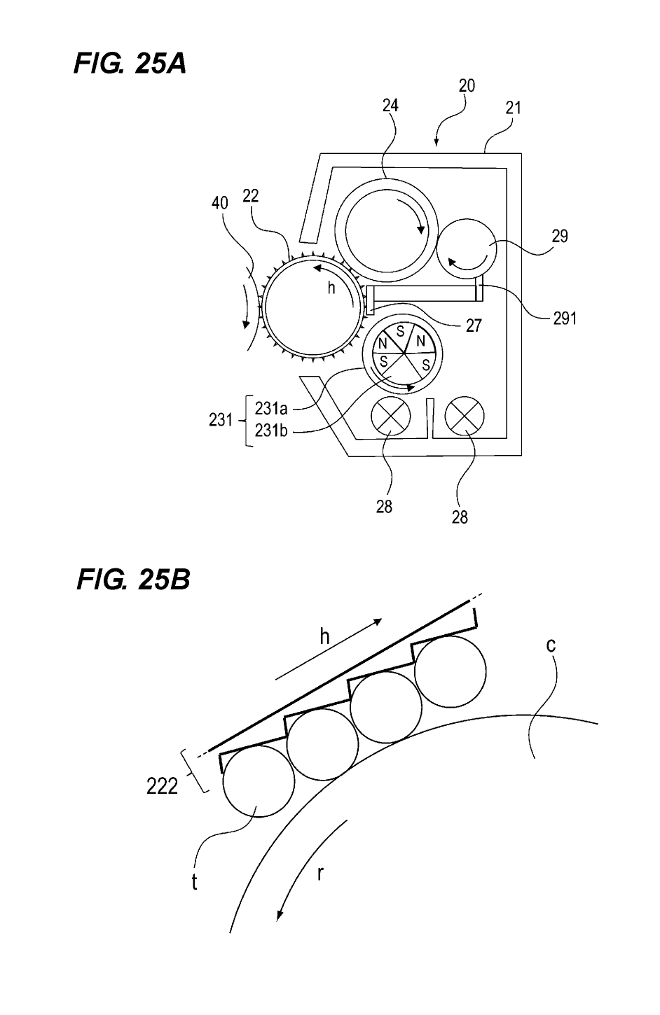

FIG. 25A is a schematic configuration diagram illustrating an image forming apparatus according to a third embodiment. In the first and second embodiments, the one-component developer is used, but in the present embodiment, a two-component developer in which a non-magnetic toner t is mixed with a magnetic carrier c is used as the developer. By using the two-component developer, the charging property and the conveyance property of the toner are improved, and thus a more stable image output can be performed. The latent image may be borne by the developer bearing member 22 or the toner collecting member 24.

The toner coating for the developer bearing member 22 will be described in detail. Instead of the developer supply member 23 that supplies the toner to the developer bearing member 22, a two-component developer bearing member 231 serving as the “developer supply member” is arranged. The two-component developer bearing member 231 includes a roller 231a that is rotatable in a direction indicated by an arrow in FIG. 25A and a plurality of permanent magnets 231b that is supported not to rotate therein. The two-component developer in the developing container 21 is agitated by the agitating member 28 and supplied to the two-component developer bearing member 231.

The developer bearing member 22 and the two-component developer bearing member 231 are arranged with a gap therebetween. The developer bearing member 22 and the toner collecting member 24 are arranged at positions at which they come into contact with each other. The toner collecting member 24 collects the toner t using electrostatic force applied by the difference of potential between the developer bearing member 22 and the toner collecting member 24.

In the two-component developer used in the present embodiment, a non-magnetic positively-charged toner in which a number average particle diameter (D50) rₜ of toners manufactured by the polymerization method is 7.6 μm, and an average degree of circularity is 0.97 is mixed with a magnetic carrier P-02 (available from the Imaging Society of Japan) in which a number average particle diameter r_{c} is 90 μm so that a toner weight ratio (hereinafter, a “TD ratio”) of the two-component developer is 10%. The supplied two-component developer is borne on the two-component developer bearing member 231 and conveyed in a direction indicated by an arrow in FIG. 25A with the rotation of the roller 231a. The two-component developer conveyed up to the supply portion facing the developer bearing member 22 comes into contact with the developer bearing member 22.

FIG. 25B is a schematic diagram illustrating behavior of the developer in the supply portion. The concave-convex structure portion 222 includes a plurality of concave portions St which the toner t is contactable and the magnetic carrier c is uncontactable. Here, the concave portion St which the toner t is contactable and the magnetic carrier c is uncontactable has the structure that is measured by the probe A corresponding to the toner particle diameter rₜ and the probe B corresponding to the magnetic carrier particle diameter r_{c} in the measurement by the AFM and recognized as the concave portion St of the present invention according to the determination criteria.

The concave-convex structure portion 222 of the present embodiment is formed of a fluorinated UV-curable resin and includes a plurality of grooves having a cross section of a concave-convex shape, the period L is 8.0 μm, the width xL of the slope SL is 7.3 μm, the depth d is 1.9 μm, the maximum inclination κR of the slope SR is 2.7, and the maximum inclination κL of the slope SL is 0.26.

The thickness D of the concave-convex structure portion 222 is 5 μm. In the supply portion, the magnetic carrier c serving as a magnetic brush is coated with the toner t, and the two-component developer is conveyed and supplied in a direction indicated by an arrow r in FIG. 25B with respect to the rotation direction h of the developer bearing member 22. The toner t that comes into contact with the developer bearing member 22 is electrically charged, comes into contact with the concave portion St of the concave-convex structure portion 222 at multiple points, and is affected by strong adhesion force. Since the adhesion force is larger than the adhesion force of the magnetic carrier c, the toner t is separated from the magnetic carrier c and migrates onto the developer bearing member 22.

By sufficiently increasing the contact frequency between the concave-convex structure portion 222 and the two-component developer, a uniform thin toner layer can be obtained according to the concave portions St of the concave-convex structure portion 222. At this time, the toner having two or more layers other than the toner constrained by the concave portion St is easily collected by the magnetic carrier c that is conveyed subsequently, and thus the toner hardly has two or more layers. Thus, the regulating member 27 may not be arranged. In the present embodiment, the two-component developer bearing member 231 is electrically floating, but a voltage may be applied by a power source (not illustrated).

In order to stably perform the coating at a low contact frequency, a charging sequence of the surface of the developer bearing member 22, the non-magnetic toner t, and the magnetic carrier c is preferably a permutation in which the magnetic carrier c is arranged between the non-magnetic toner t and the surface of the developer bearing member 22. The reason will be described below.

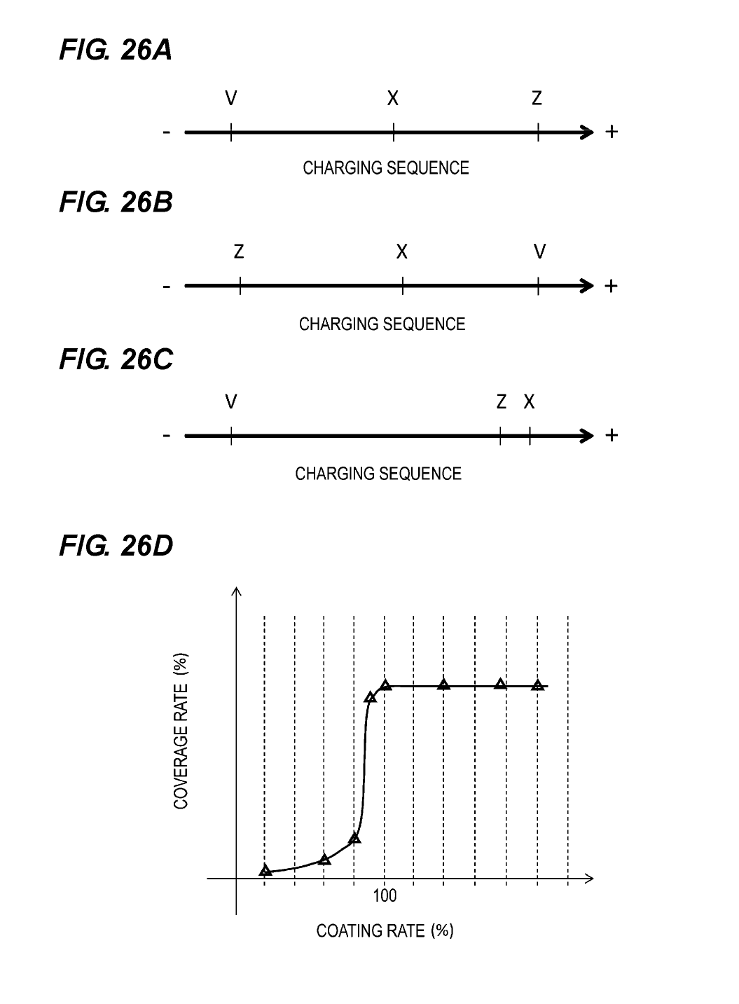

FIGS. 26A and 26B are schematic diagrams illustrating a charging sequence (FIG. 26A) in the case of a positive polarity toner and a charging sequence (FIG. 26B) in the case of a negative polarity toner. Here, V indicates a material of the concave-convex structure portion 222, X indicates the magnetic carrier c, and Z indicates the toner t. Under this condition, a charging sequence difference between the toner t and the concave-convex structure portion 222 is larger than a charging sequence difference between the toner t and the magnetic carrier c. For this reason, when the toner t comes into contact with and rubs against the concave-convex structure portion 222 and is electrically changed, electrostatic adhesion force stronger than electrostatic adhesion force between the toner t and the magnetic carrier c is generated, the toner t is separated from the magnetic carrier c, and easily attached to the concave-convex structure portion 222.

On the other hand, even in a charging sequence illustrated in FIG. 26C, a charging sequence difference between the toner t(Z) and the concave-convex structure portion 222(V) is larger than a charging sequence difference between the toner t(Z) and the magnetic carrier c(X). However, in the case of this permutation, the toner t is likely to have the negative polarity due to friction with the magnetic carrier c and have the positive polarity due to frication with the concave-convex structure portion 222. When the toners having the different polarities exist together as described above, the toners other than the toners constrained by the concave portion St are attached to each other, and the number of toners having two or more layers increases. Due to the above reasons, it is desirable that the charging sequence of the toner t, the magnetic carrier c, and the concave-convex structure portion 222 be a permutation in which the magnetic carrier c is arranged between the toner t and the concave-convex structure portion 222. A method of deciding the charging sequence will be described later.

FIG. 26D illustrates a result of measuring a coverage rate of the toner with which the concave-convex structure portion 222 is coated when a coating rate is varied by adjusting the toner weight ratio (hereinafter, the “TD ratio”) of the two-component developer. In order to perform the coating stably at the low contact frequency, the coating rate of the two-component developer serving as a portion at which the surface of the magnetic carrier c is coated with the toner t is preferably 90% or higher.

The reason will be described below. A method of measuring the coating rate and the coverage rate will be described later. At the coating rate around 90%, the coverage rate abruptly changes. The reason is considered as follows. In order to cause a sufficient amount of the toner t to migrate to the concave portion St in the supply portion, it is necessary to increase the contact frequency between the toner t and the concave portion St and cause a probability x that the toner t will migrate to the concave portion St to be much larger than a probability y that the toner t is peeled off from the concave portion St by the magnetic brush.

When the coating rate of the two-component developer is high, the number of toners coming into contact with the concave portion St, the contact frequency is increased, and since the surface of the magnetic carrier c is coated with the toner t, the surface of the magnetic carrier c is hardly exposed, and the probability x is likely to be relatively larger than the probability y. For this reason, when the coating rate is 90% or higher at which the surface of the magnetic carrier c is hardly exposed, the coverage rate is considered to be dramatically improved. Due to the above reason, it is desirable that the coating rate be 90% or higher.

On the other hand, when the coating rate exceeds 200%, the proportion of the toner t stacked on the toner t of the single layer coming into contact with the concave portion St among the toners t with which the concave-convex structure portion 222 is coated abruptly increases. It is because the magnetic carrier c is hardly coated with three or more layers of the toner t, and the toners t that are not controlled by the magnetic carrier c increases. For this reason, in the case of the configuration in which the regulating member 27 is not used, it is desirable that the coating rate be 200% or less. Except the members described above, a detailed description of the collection of the toner t by the toner collecting member 24 which are the same as in the first and second embodiments is omitted.

### <Method of Deciding Charging Sequence>

Only the magnetic carrier c is inserted into the developing container 21 of the developing apparatus 20 and undergoes a normal development rotation operation for one minute. At this time, the regulating member 27, the toner collecting member 24, the transfer member 40, and the like are separated from one another in advance so that the developer bearing member 22 and the two-component developer bearing member 231 enters an electrically floating state, and only the magnetic carrier c borne on the two-component developer bearing member 231 comes into contact with the developer bearing member 22.

A probe of a surface electrometer MODEL347 (available from TREK, Inc) is installed to face the developer bearing member 22 at the position of the regulating member 27, and a surface potential of the developer bearing member 22 is measured. A difference of potential (a post operation potential−a pre operation potential) before and after a rotation operation is measured, and when the difference of potential is positive, the concave-convex structure portion 222 of the developer bearing member 22 can be determined to be at the positive side of the magnetic carrier c on the charging sequence, and when the difference of potential is negative, the concave-convex structure portion 222 of the developer bearing member 22 can be determined to be at the negative side of the magnetic carrier c on the charging sequence. On the other hand, since it is possible to determine whether the toner t is on the positive side or the negative side of the magnetic carrier c on the charging sequence due to triboelectric charging of the magnetic carrier c and the toner t, it is possible to decide a relative charging sequence of the three members.

### <Method of Measuring Coating Rate>

The sufficiently agitated two-component developer of about 0.3 g in the developing container 21 is mixed into a mixed liquid of water and a surfactant (for example, a Yashinomi detergent), the molten toner t is separated from the magnetic carrier c, and weights of the toner t and the magnetic carrier c are measured, and a TD ratio q of the two-component developer is obtained. A coating rate S is calculated by the following Formula using the TD ratio q.

$$\begin{matrix}( Formula 7 ) & \\ \text{Coating rate (\%)} = \frac{ρ crcq}{4 ρ t rt ( 100 - q )} \times 100 , & [ Math . 7 ]\end{matrix}$$

where ρₜ indicates the true density of the toner, ρ_{c} indicates the true density of the magnetic carrier, rt indicates the average particle diameter of the toner, and rc indicates the average particle diameter of the magnetic carrier. q indicates the TD ratio.

The coating rate of the two-component developer used in the present embodiment which is measured based on the density ρₜ (1.05 g/cm³) of the toner t and the density ρ_{c} (4.8 g/cm³) of the magnetic carrier c using the above Formula and a true density measurement method which will be described later is 150%.

### <Method of Measuring True Density ρ>

The true densities of the toner t and the magnetic carrier c are measured using a dry automatic densimeter Accupyc 1330 (available from Shimadzu Corporation) according to the operation manual of the measuring apparatus. At this time, the true density is automatically measured using a measurement cell of 10 cm³, and average values of 5 measured values are used as the true densities ρₜ and ρ_{c}.

### <Method of Measuring Average Particle Diameter of Magnetic Carrier>

The average particle diameter of the magnetic carrier is measured using a laser diffraction particle size distribution measuring apparatus SALD-3000 (available from Shimadzu Corporation) according to the operation manual of the measuring apparatus. Specifically, the magnetic carrier of 0.1 g is introduced into the apparatus, the measurement is performed, the number of samples is measured for each channel, the median size d50 is calculated, and the average particle diameter r_{c} of the magnetic carrier c is obtained. Incidentally, rₜ indicates the average particle diameter of the toner t.

### <Method of Measuring Coverage Rate>

The coated concave-convex structure portion 222 is photographed by a microscope (VHX-5000 available from Keyence Corporation), only an area (px) of the toner portion is extracted using image processing software (a Photoshop available from Adobe Systems Inc.), and a proportion of the area of the toner portion to the entire area is calculated.

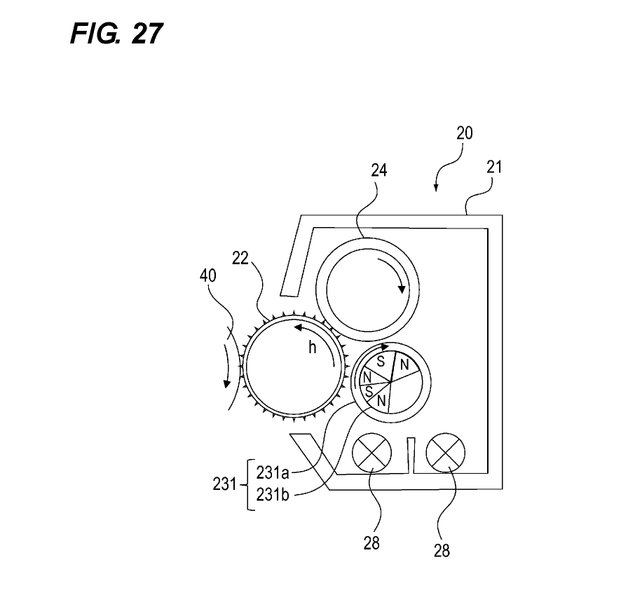

FIG. 27 is a schematic configuration diagram illustrating an image forming apparatus according to a modified example of the third embodiment of the present invention. In the image forming apparatus, in the supply portion, the two-component developer bearing member 231 rotates in an opposite direction R to the rotation direction h of the developer bearing member 22, but in the present image forming apparatus, the two-component developer bearing member 231 rotates in the same direction. Further, the two-component developer bearing member 231 is arranged with a gap of several hundred micrometers (μm) from the toner collecting member 24, and the two-component developer borne on the two-component developer bearing member 231 comes into contact with the toner collecting member 24 in the facing cleaning portion.

A voltage is applied from a power source (not illustrated) to the two-component developer bearing member 231 and the toner collecting member 24, and the difference of potential of causing the toner t collected on the toner collecting member 24 to migrate to the two-component developer bearing member 231 is formed between the two-component developer bearing member 231 and the toner collecting member 24. For this reason, the toner t collected on the toner collecting member 24 can be collected into the two-component developer borne on the two-component developer bearing member 231 and easily returned to the agitation process performed by the agitating member 28. Thus, the cleaning member 29 is unnecessary, and the configuration can be reduced in size and simplified. The regulating member 27 may be arranged between the two-component developer bearing member 231 and the toner collecting member 24.

### Fourth Embodiment

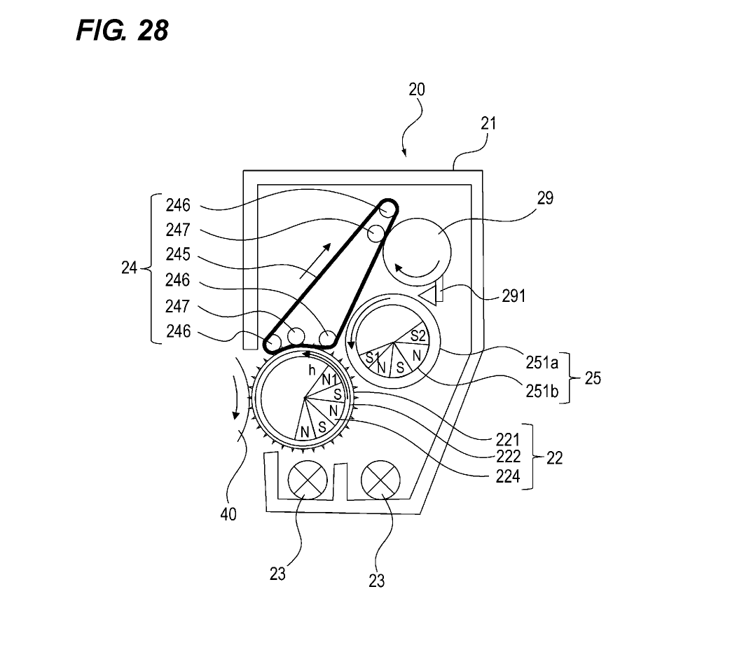

FIG. 28 is a schematic configuration diagram illustrating an image forming apparatus according to a fourth embodiment of the present invention. In the third embodiment, the permanent magnet is not arranged in the developer bearing member 22, and the two-component developer is not borne on the developer bearing member 22, but in the present embodiment, a plurality of permanent magnets 224 is supported not to rotate in the developer bearing member 22, and the two-component developer is borne on the developer bearing member 22. The two-component developer is a developer in which the non-magnetic toner t is mixed with the magnetic carrier c.

The developer bearing member 22 and the toner collecting member 24 are arranged at positions at which they come into contact with each other. The toner collecting member 24 collects the toner t through the electrostatic force applied by the difference of potential between the developer bearing member 22 and the toner collecting member 24.

In the process in which the developer bearing member 22 bears and conveys the two-component developer, the contact frequency between the concave-convex structure portion 222 and the two-component developer increases, and the toner coating for the developer bearing member 22 is improved, and thus more stable image output can be performed.

In this regard, a developer collecting member 25 that collects part of the developer borne on the developer bearing member 22 is arranged between the developer supply member 23 and the toner collecting member 24. The developer collecting member 25 includes a plurality of permanent magnets 251b that is supported not to rotate therein. The developer collecting member 25 collects the developer through magnetic force.

The developer bearing member 22 and the developer collecting member 25 are arranged with a gap therebetween. The developer collecting member 25 forms a magnetic field such that the permanent magnets in the developer bearing member 22 collaborate with the permanent magnets in the developer collecting member 25, and collects the developer through the magnetic force applied by the magnetic field. The latent image may be borne on any of the developer bearing member 22 and the toner collecting member 24.

The toner coating for the developer bearing member 22 will be described in detail. The two-component developer in the developing container 21 is supplied to the developer bearing member 22 through the developer supply member 23 that doubles as the agitating member. The developer bearing member 22 includes a latent image bearing member 221 that bears the latent image, a concave-convex structure portion 222 including a plurality of concave portions St having a surface which the toner t is contactable and the magnetic carrier c is uncontactable, and a plurality of permanent magnets 224 fixedly arranged therein.

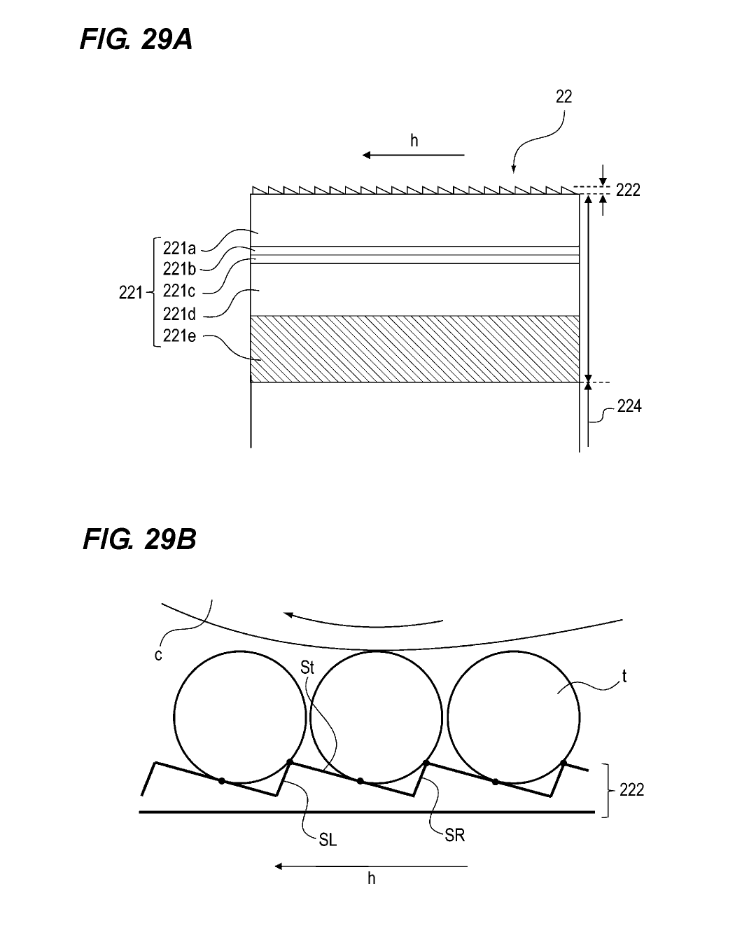

FIG. 29A is a schematic diagram illustrating a cross section of the developer bearing member 22. In the present embodiment, the photosensitive drum is described as an example of the latent image bearing member 221, but the photosensitive belt, the electrode drum, or the like may be used. Due to the magnetic field formed by the permanent magnets 224 and the rotation of the developer bearing member 22 in a direction indicated by an arrow h in FIG. 29A, the two-component developer is borne on the developer bearing member 22 and conveyed in the direction indicated by the arrow h.

FIG. 29B is a schematic diagram for describing behavior of the two-component developer on the concave-convex structure portion 222 in the conveyance process. In the conveyance process, the moving velocity of the concave-convex structure portion 222 and the conveyance velocity of the two-component developer are not technically equal but have a velocity difference. For example, in a portion on a pole that is strongly affected by the permanent magnets, the two-component developer is likely to be under force in the radial direction of the developer bearing member 22 (Fr), and the conveyance velocity of the two-component developer is likely to be slower than the moving velocity of the concave-convex structure portion 222. At this time, the toner t comes into contact with the concave portion St of the concave-convex structure portion 222 at multiple points, is separated from the magnetic carrier c, and equally filled in the direction of the steep slope surfaces SR of the concave portions St. As a result, in the conveyance process, a uniform thin toner layer can be obtained according to the concave portions St of the concave-convex structure portion 222.

At this time, except the toner constrained by the concave portion St, the toner having two or more layers are easily collected by the magnetic carrier that is conveyed subsequently, and the toner hardly has two or more layers. The regulating member 27 may be arranged between the developer collecting member 25 and the toner collecting member 24. Thereafter, the two-component developer is conveyed up to a developer collecting portion facing the developer bearing member 22 and the developer collecting member 25, and except the toner constrained by the concave portions St of the concave-convex structure portion 222, the toner is collected by the developer collecting member 25 through the magnetic force. The developer collecting member 25 is a two-component developer bearing member 25 that bears the two-component developer and includes a sleeve 251a that is rotatable in a direction indicated by an arrow in FIG. 29B and a plurality of permanent magnets 251b that is fixedly arranged therein.

Referring back to FIG. 28, in the developer collecting portion, the permanent magnets of the developer bearing member 22 and the developer collecting member 25 are arranged to have different poles (N1 and S1 in FIG. 28) and form the magnetic field in collaboration with each other. Due to the magnetic force acting on the developer collecting portion and the rotation of the sleeve 251a, the two-component developer is collected from the developer bearing member 22 to the developer collecting member 25. The collected two-component developer is conveyed with the rotation of the sleeve 251a, separated from the developer collecting member 25 due to influence of the same neighboring poles (S1 and S2 in FIG. 28) of the permanent magnets 251b, and returned to the agitation process again, and then it is repeated.

On the other hand, the toner on the concave portion St that is not collected by the developer collecting member 25 but remains on the concave-convex structure portion 222 is conveyed to the toner collecting portion facing the toner collecting member 24, and the toner of the non-image portion is collected. The toner collecting member 24 includes a belt member 245 that is rotatably supported, a driving roller 246 that suspends the belt member 245, and a voltage applying member 247 that supplies a voltage through a power source (not illustrated). Due to the belt shape, it is easy to secure a contact distance with the developer bearing member 22, and by arranging the voltage applying member 247 below the contact region, it is possible to further suppress the jumping development in the non-contact portion.

The toner collecting member 24 may be, for example, a roller having a cylindrical shape rather than a belt shape. The toner collected by the difference of potential in the toner collecting portion is conveyed up to the cleaning portion facing the cleaning member 29 with the rotation of the belt member 245. The cleaning member 29 is a brush member in which conductive fiber is formed in a brush form, and a voltage is applied from a power source (not illustrated) to the cleaning member 29.

In the cleaning portion, the cleaning is performed such that the collected toner on the belt member 245 migrates to the cleaning member 29 due to the difference of potential. The cleaning member may perform the cleaning through a member formed of a porous foam material whose surface has elasticity, a so-called magnetic brush member that bears magnetic particles and form the magnetic particles in a magnetic brush form, a fixed regulating member, or the like in addition to the brush member. A detailed description of the remaining configuration that is the same as in the first to third embodiments except the member is omitted.

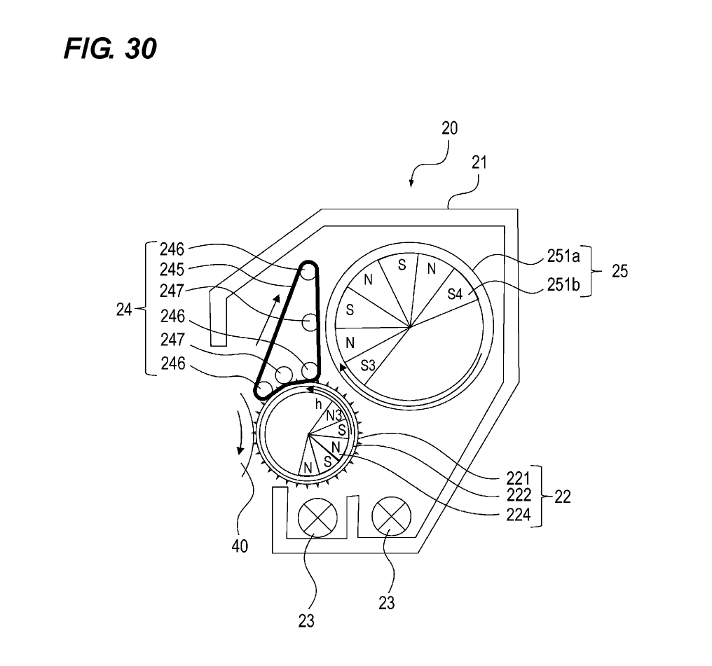

FIG. 30 is a schematic configuration diagram illustrating an image forming apparatus according to a modified example of the fourth embodiment of the present invention. In the image forming apparatus of the fourth embodiment, in the developer collecting portion, the developer collecting member 25 rotates in the opposite direction to the rotation direction h of the developer bearing member 22, whereas in the present image forming apparatus of the modified example, the developer collecting member 25 rotates in the same direction as the rotation direction h of the developer bearing member 22. In addition, the developer collecting member 25 is arranged with a gap of several hundred micrometers (μm) from the toner collecting member 24, and the two-component developer borne on the developer collecting member 25 comes into contact with the toner collecting member 24 in the facing cleaning portion.

A voltage is applied from a power source (not illustrated) to the developer collecting member 25 and the toner collecting member 24, and the difference of potential is formed so that the collected toner on the toner collecting member 24 migrates to the developer collecting member 25. Thus, the collected toner on the toner collecting member 24 can be collected into the two-component developer borne on the developer collecting member 25 and easily returned to the agitation process. In this regard, the cleaning member 29 is unnecessary, and the configuration can be reduced in size and simplified. The regulating member 27 may be arranged between the developer collecting member 25 and the toner collecting member 24. Further, in order to regulate an amount of the developer to be borne on the developer bearing member 22, a regulating member may be arranged between the developer supply member 23 and the developer collecting member 25.

### Fifth Embodiment

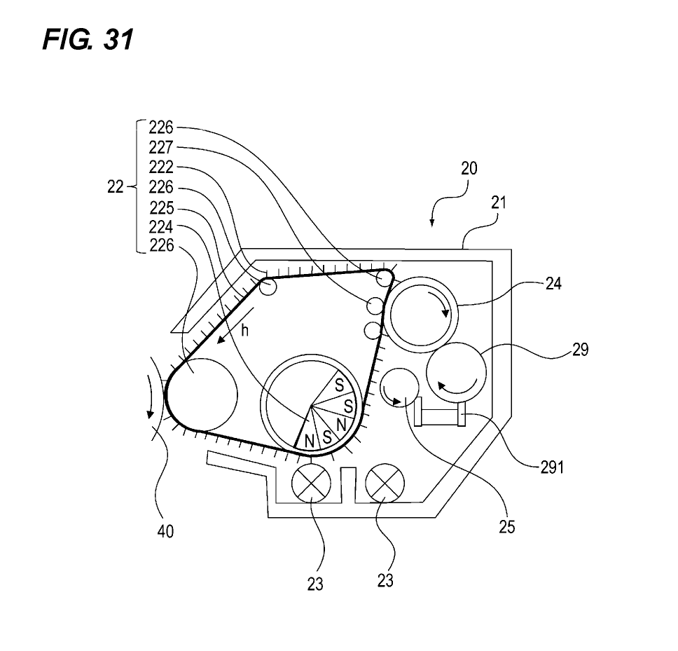

FIG. 31 is a schematic configuration diagram illustrating an embodiment of the image forming apparatus of the present invention. In the fourth embodiment, a plurality of permanent magnets 251b is arranged in the developer collecting member 25, whereas in the present embodiment, the developer collecting member 25 is formed of a magnetic material or a metallic material having high magnetic permeability. Since the developer collecting member 25 has a simple configuration, it is possible to cope with the size reduction of the image forming apparatus. The latent image may be borne on any of the developer bearing member 22 and the toner collecting member 24.

The developer bearing member 22 and the developer collecting member 25 are arranged with a gap therebetween. The developer collecting member 25 forms a magnetic field such that the permanent magnets 224 in the developer bearing member 22 collaborate with the developer collecting member 25, and collects the developer through the magnetic force applied by the magnetic field.

The toner coating for the developer bearing member 22 will be described in detail. The two-component developer in the developing container 21 is supplied to the developer bearing member 22 through the developer supply member 23 that doubles as the agitating member. the developer bearing member 22 includes a photosensitive belt 225 serving as the latent image bearing member 221, a concave-convex structure portion 222 that is formed thereabove and includes a plurality of concave portions St which the toner t is contactable and the magnetic carrier c is uncontactable, a plurality of permanent magnets 224 that is supported not to rotate in the photosensitive belt 225, a driving roller 226 that suspends the photosensitive belt 225, and a voltage applying member 227 that supplies a voltage through a power source (not illustrated).

The developer bearing member 22 and the toner collecting member 24 are arranged at positions at which they come into contact with each other. The toner collecting member 24 collects the toner t through the electrostatic force applied by the difference of potential between the developer bearing member 22 and the toner collecting member 24.

In the present embodiment, the photosensitive belt is described as an example of the latent image bearing member 221, but an electrode belt, a photosensitive drum, an electrode drum, or the like may be used. Due to the magnetic field formed by the permanent magnets 224 and the rotation of the developer bearing member 22 in a direction indicated by an arrow h in FIG. 31, the two-component developer is borne on the developer bearing member 22 and conveyed in the direction indicated by the arrow h. In the conveyance process, the developer bearing member 22 is coated with the uniform thin toner layer according to the concave portion St of the concave-convex structure portion 222.

At this time, the toner having two or more layers other than the toner constrained by the concave portion St is easily collected by the magnetic carrier c that is conveyed subsequently, and thus the toner hardly has two or more layers. Thereafter, the two-component developer is conveyed up to a developer collecting portion facing the developer bearing member 22 and the developer collecting member 25, and except the toner constrained by the concave portions St of the concave-convex structure portion 222, the toner is collected by the developer collecting member 25 through the magnetic force.

The developer collecting member 25 is formed of a magnetic material or a metallic material having high magnetic permeability and arranged to be rotatable in a direction indicated by an arrow in FIG. 31. In the present embodiment, the developer collecting member 25 is rotatable but may have a configuration in which a thin plate of a material is fixedly arranged. In the developer collecting portion, the magnetic field is formed by collaboration of the permanent magnet 224 and the developer collecting member 25, and the two-component developer is collected by the developer collecting member 25 through the magnetic force. A detailed description of the remaining configuration that is the same as in the first to fourth embodiments except the above-described members is omitted.

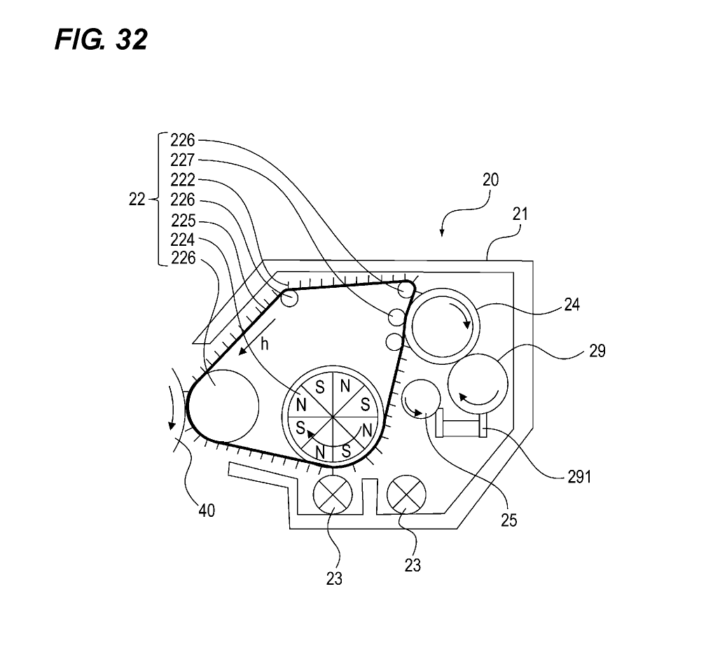

FIG. 32 is a schematic configuration diagram illustrating an embodiment of the image forming apparatus of the present invention. In the image forming apparatus of FIG. 31, the permanent magnet 224 is supported not to rotate inside (in) the photosensitive belt 225 serving as the “developer bearing member,” but in the present image forming apparatus, a plurality of permanent magnets 224 is supported to be rotatable in a direction indicated by an arrow in FIG. 31 inside (in) the photosensitive belt 225 serving as the “developer bearing member.” As the permanent magnet 224 rotates, it is easy to set the relative velocity to the moving velocity of the concave-convex structure portion 222 and the conveyance velocity of the two-component developer. Thus, it is possible to increase the contact frequency between the concave-convex structure portion 222 and the two-component developer, and it is possible to reduce the size of the configuration and increase the velocity.

According to the first to fifth embodiments, coating of the toner of the high density thin layer is uniformly performed according to the concave portions St of the concave-convex structure portion 222 formed on the surface of the developer bearing member 22. Further, the toner of the non-image portion is collected according to an image pattern through the toner collecting member that is arranged, to face the developer bearing member, at a stream position further than the developer supply member and an upstream position further than the transfer member in the rotation direction of the developer bearing member. The toner remaining on the developer bearing member after the collection is constrained by the concave portion St, and thus the high-density thin-layer toner image is maintained. Through the above configuration, it is possible to form the toner image of the high density thin layer stably, and it is possible to output the high-quality image with a small toner amount.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2015-110639, filed May 29, 2015, which is hereby incorporated by reference herein in its entirety.

What is claimed is:

1. An image forming apparatus, comprising:
a developing container that accommodates a developer;
a developer bearing member that is arranged in an opening of the developing container and bears the developer;
a latent image forming apparatus that forms an electrostatic latent image on the developer bearing member;
a developer supply member that is arranged in the developing container and supplies the developer to the developer bearing member;
a toner collecting member that is arranged in the developing container and collects a toner with which the developer bearing member is coated; and
a transfer member that transfers a toner image remaining on the developer bearing member to a transfer material after the collecting,
wherein the developer supply member, the toner collecting member, and the transfer member are arranged in order from an upstream side in a rotation direction of the developer bearing member, and
the developer bearing member bears an electrostatic image and includes a plurality of concave portions, and each of the concave portions is configured such that a virtual ball having an average particle diameter of the toner is contactable to an inner surface of the concave portion except an edge of the concave portion formed at an outmost surface side of the developer bearing member of the concave portion, and the virtual ball protrudes outwards further than an outmost surface position of the developer bearing member when the virtual ball is positioned at a lowest position in the concave portion,
a proportion of the concave portions per unit area in at least a toner bearing region of the developer bearing member is 55% or higher, and
a difference of potential is formed between the developer bearing member and the toner collecting member, and the toner borne on a non-image region of the developer bearing member is collected through the difference of potential.

2. An image forming apparatus, comprising:
a developing container that accommodates a developer;
a developer bearing member that is arranged in an opening of the developing container and bears the developer;
a latent image forming apparatus that forms an electrostatic latent image on the developer bearing member;
a developer supply member that is arranged in the developing container and supplies the developer to the developer bearing member;
a toner collecting member that is arranged in the developing container and collects a toner with which the developer bearing member is coated; and
a transfer member that transfers a toner image remaining on the developer bearing member to a transfer material after the collecting,
wherein the developer supply member, the toner collecting member, and the transfer member are arranged in order from an upper stream in a rotation direction of the developer bearing member,
the toner collecting member bears an electrostatic image,
the developer bearing member includes a plurality of concave portions,
each of the concave portions is configured such that a virtual ball having an average particle diameter of the toner is contactable to an inner surface of the concave portion except an edge of the concave portion formed at an outmost surface side of the developer bearing member of the concave portion, and the virtual ball protrudes outwards further than an outmost surface position of the developer bearing member when the virtual ball is positioned at a lowest position in the concave portion,
a proportion of the concave portions per unit area in at least a toner bearing region of the developer bearing member is 55% or higher, and
a difference of potential is formed between the developer bearing member and the toner collecting member, and the toner on a surface of the developer bearing member is collected through the difference of potential.

3. The image forming apparatus according to claim 1,
wherein the developer is a one-component developer,
between the developer bearing member and the developer supply member, the developer bearing member and the toner collecting member are arranged at positions to come into contact with each other, and
the toner is collected through electrostatic force applied by the difference of potential between the developer bearing member and the toner collecting member.

4. The image forming apparatus according to claim 1,
wherein the developer is a two-component developer in which a non-magnetic toner is mixed with a magnetic carrier,
the developer supply member includes a plurality of permanent magnets that is supported not to rotate therein,
the developer bearing member and the developer supply member are arranged with a gap therebetween,
the developer bearing member and the toner collecting member are arranged at positions to come into contact with each other, and
the toner is collected through electrostatic force applied by the difference of potential between the developer bearing member and the toner collecting member.

5. The image forming apparatus according to claim 1,
wherein the developer is a two-component developer in which a non-magnetic toner is mixed with a magnetic carrier,
a developer collecting member that collects a part of the developer borne on the developer bearing member is arranged between the developer supply member and the toner collecting member, and
the developer collecting member collects the developer through a magnetic force.

6. The image forming apparatus according to claim 5,
wherein each of the developer bearing member and the developer collecting member includes a plurality of permanent magnets that is supported not to rotate therein,
the developer bearing member and the developer collecting member are arranged with a gap therebetween,
the magnetic field is formed by collaboration of the permanent magnets in the developer bearing member and the permanent magnets in the developer collecting member, and the developer is collected through the magnetic force applied by the magnetic field,
the developer bearing member and the toner collecting member are arranged at positions to come into contact with each other, and
the toner is collected through electrostatic force applied by the difference of potential between the developer bearing member and the toner collecting member.

7. The image forming apparatus according to claim 5,
wherein the developer bearing member includes a plurality of permanent magnets that is arranged not to rotate therein,
the developer collecting member is formed of a magnetic material or a metallic material having high magnetic permeability,
the developer bearing member and the developer collecting member are arranged with a gap therebetween,
the magnetic field is formed by collaboration of the permanent magnets in the developer bearing member and the permanent magnets in the developer collecting member, and the developer is collected through magnetic force applied by the magnetic field,
the developer bearing member and the toner collecting member are arranged at positions to come into contact with each other, and
the toner is collected through electrostatic force applied by the difference of potential between the developer bearing member and the toner collecting member.

8. The image forming apparatus according to claim 5,
wherein the developer bearing member includes a plurality of permanent magnets that is supported not to rotate therein,
the developer collecting member is formed of a magnetic material or a metallic material having high magnetic permeability,
the developer bearing member and the developer collecting member are arranged with a gap therebetween,
the magnetic field is formed by collaboration of the permanent magnets in the developer bearing member and the developer collecting member, and the developer is collected through magnetic force applied by the magnetic field,
the developer bearing member and the toner collecting member are arranged at positions to come into contact with each other, and
the toner is collected through electrostatic force applied by the difference of potential between the developer bearing member and the toner collecting member.

9. The image forming apparatus according to claim 4,
wherein in a charging sequence of a surface of the developer bearing member, the non-magnetic toner, and the magnetic carrier, the magnetic carrier is arranged between the non-magnetic toner and the surface of the developer bearing member.

10. The image forming apparatus according to claim 4,
wherein a coating rate in the two-component developer is 90% or higher, and
the coating rate satisfies
$$\text{Coating rate (\%)} = \frac{ρ crcq}{4 ρ t rt ( 100 - q )} \times 100 , \qquad [ Math . 8 ]$$
where ρₜ indicates the true density of the toner, ρ_{c} indicates the true density of the magnetic carrier, rt indicates the average particle diameter of the toner, and rc indicates the average particle diameter of the magnetic carrier. q indicates the TD ratio.
